(19) United States
(12) Patent Application Publication
(10) Pub. No.: US 2005/0086384 A1
(43) Pub. Date: Apr. 21, 2005

(54) System and method for replicating, integrating and synchronizing distributed information

(76) Inventor: Johannes Ernst, Sunnyvale, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/934,206

(22) Filed: Sep. 3, 2004

Related U.S. Application Data
(60) Provisional application No. 60/500,814, filed on Sep. 4, 2003.

(51) Int. Cl. G06F 15/16

(52) U.S. Cl. 709/248; 709/201

(57) ABSTRACT

An extensible protocol to replicate, integrate and synchronize distributed information is described which may be implemented in a computer system. A system and method for replicating, integrating and synchronizing distributed information is also described.

### PRIORITY CLAIM/RELATED CASE

This patent application claims priority under 35 USC 119(e) to U.S. Provisional Patent Application Ser. No. 60/500,814 entitled “System and Method for Replicating, Integrating and Synchronizing Distributed Objects (X-PRISO™)” filed on Sep. 4, 2003 which is incorporated by reference herein in its entirety.

### FIELD OF THE INVENTION

The invention relates generally to a system and method for replicating, integrating and synchronizing distributed information and in particular to a computer implemented system and method for replicating, integrating and synchronizing distributed information.

### BACKGROUND OF THE INVENTION

At the heart of all collaborative processes, whether for business or private reasons, whether it involves computers or not, lies the sharing of information. To collaborate, the participants in a collaboration (that may be human and/or machines) need to have a common baseline of shared information on which they operate. It would not be a collaboration, if a collaboration participant did not have any access to shared information, if the only information that one had access to was incorrect or out of date with no avenue of getting an up-to-date version of the information, or if the structure of the information was unsuitable for the collaboration, or the purpose behind the collaboration. All collaboration participants 101 must have access to the same, shared information 102 as shown in FIG. 1.

Thus, all software systems supporting participatory, collaborative interaction patterns need to meet the two following essential requirements:
They must allow collaboration participants to have access to the shared information that the participants need to fulfill their role in the collaboration, the shared information being available in a form that represents its semantics as it is relevant to the collaboration, in particular the internal relationships between the pieces comprising the shared information (see example below).
They must ensure that changes (i.e. additions, deletions, or modifications) of shared information, needed by other collaboration participants during the course of the collaboration by any one collaboration participant, are communicated to all other participants who need it. This quality is called “information coherence”. This must happen “sufficiently fast”, i.e. fast enough for the application domains' requirements. Such requirements vary, and include, as special cases, what often is called “synchronous” or “asynchronous” collaboration.

To meet these two essential requirements for collaborative software, software architectures supporting collaborations are traditionally centralized. They either employ a classic, client-server architecture, or a standard web architecture, both of which are centralized. This centralized architecture is shown graphically in FIG. 2. Here, collaboration participants 201 have access to the shared information 202 through the centralized system 203.

Centralization is a simple solution that addresses the above requirements. By virtue of centralization, there is only a single (master) copy of the shared information 202 in the one central location 203, which can easily be made accessible to all collaboration participants. This one single copy of the shared information is inherently up to date. Of course, it requires that all collaboration participants have on-line access to the information at the central location whenever they need it. As those skilled in the art know, this kind of architecture has been applied broadly in a variety of industries for a large number of applications, some of which are:
collaboration software and collaborative environments
file sharing, content management systems and version control / revision control systems
supply chain management systems
catalog management systems
contact management systems
calendar management systems
sales force automation applications
media and digital rights management software
application software with a rich (stationary or mobile) client that needs to function even while disconnected.

However, more recently, the personal, business and technical circumstances of collaboration have begun to change, and the need for more decentralized collaboration architectures has become apparent. For example, with the rise of distributed teams and e-business, participants from more than one organization, or even participants from the many members of a whole value chain, often have to collaborate. This collaboration often needs to include participants currently at home or on travel. In such a cross-company collaboration, one cannot assume that there is one central location in which all collaboration-relevant information can be stored, at which all related software will run, or from which all related software will be centrally deployed and managed. Security considerations, ownership and control considerations among the participating organizations, the problem of unreliable networks (in particular for mobile users), software deployment, extensibility, (legacy) integration and maintainability considerations all make a fully centralized architecture difficult or impossible under these and many other circumstances. Often, similar constraints exist for collaborations even within a single organization.

But even in cases where centralization may be possible, a more decentralized software architecture may be more appropriate. For example, a suitably constructed decentralized architecture may provide higher reliability and availability than a centralized one, as it may not have a single point of failure and less potential for resource contention. In many cases, it may also be desirable for collaboration participants (whether human or machine) to use different versions of the same software interface, or even entirely different software interfaces to the same collaboration. This is called heterogeneous collaboration, i.e. a collaboration whose participating nodes are of different types, often developed using different technologies by different actors (such as different software companies). Such software heterogeneity can be implemented much more easily using a decentralized architecture.

Further, the increasing adoption of autonomously communicating devices that many would like to include in collaborations (e.g. WiFi-enabled laptops, cell phones, PDAs, embedded devices) and the growth of ad-hoc networking creates a need for more decentralized collaboration architectures.

Constructing decentralized collaboration software is a much more complex problem than constructing centralized software. Unlike in the centralized case, where all shared information can be kept in the same location, a decentralized architecture has to manage and synchronize shared information that invariably exists in several, or even many copies distributed across several different locations. FIG. 3 illustrates a decentralized system consisting of many nodes 303 in which many copies 302 of the same information exist, each of which is accessed by a different collaboration participant 301. Nodes 303 need to communicate with each other in a manner that ensures information coherence; the circular topology shown in FIG. 3 is only one of many different topologies that may be used for communication between nodes in a decentralized collaboration system.

In the case of business-to-business collaboration, the shared information may be distributed across server computers owned and maintained by multiple companies. In many cases, the shared information may be distributed over several desktop, server, handheld computers, cell phones, or embedded or pervasive devices that are—permanently or intermittently—connected over a variety of networks. Many other scenarios are possible.

In the distributed architecture shown in FIG. 3, all nodes 303 hold a copy of the exact same information 302. But that is a special case. FIG. 4 shows a more general case of a decentralized collaboration system: some nodes 403 may hold the totality of the shared information, but many do not; they only hold a fraction 402 of the shared information, typically the fraction needed by the collaboration participant 401 connected to the particular node 403. As long as any node in the decentralized system can obtain required information from other nodes when it needs to, and synchronize itself correctly, this partially-replicated scenario in FIG. 4 is often preferable to that of FIG. 3, where all shared information exists everywhere. Among other benefits, the partially-replicated scenario allows substantially reduced resource consumption (both in terms of memory and bandwidth) because typically, not all collaboration participants require simultaneous access to all the shared information. It also, potentially, allows for better security, as this scenario supports different access rights to some of the shared information for different participants.

The partially-replicated scenario also can uniquely take advantage of internal relationships between individual pieces of the shared information: for example, an “accounting” node may hold information about a customer, and the customer's current account balance (i.e. there is a relationship between the customer and the account balance). Another node (the “shipping” node) may hold another replica of the customer object, but instead of also holding the account balance, hold a plurality of to-be-shipped items and the relationships between the to-be-shipped items in the customer, neither of which are held by the “accounting” node. Being able to support this scenario is thus important for supporting collaboration in the context of already-existing information systems. Further, existing cross-functional information models can be used directly as the information model governing the sharing of information according to the present invention, as discussed in more detail below.

While some well-known “application integration” and related approaches allow one system to export all or part of the information it manages to a second system (which, in addition, may or may not manage its own information), those approaches typically do not allow the second system to modify the imported information, to automatically propagate the changes back to the first system where it can be used to update the information held there, to guarantee that no inconsistent updates are being made to shared information in parallel in either system, or to traverse relationships between information, some of which is only held by the first and some of which is only held by the second information system at the current point in time, in a uniform manner either by the first, the second, or a third information system. Where such functionality is available, it is typically tied to a strict work flow that, in essence, carries the only copy of the shared information that may be updated; requiring all collaboration participants to follow a strict work flow is very undesirable in practice as collaborative behavior often does not naturally follow a work flow.

To further complicate matters in the case of a decentralized architecture, one cannot assume that all nodes of the distributed system are available and connected at all times. This is particularly true at the network's edge where PCs and other computing devices (such as mobile, embedded and pervasive devices) can join and leave the network at any time, voluntarily or involuntarily. When a node or a critical edge in the network become temporarily unavailable, timely synchronization between all the nodes necessarily becomes (temporarily) impossible. Depending on usage patterns, this can lead to substantial information inconsistency across the distributed system very quickly. Further, depending on the network topology, only some nodes in such a distributed system might be able to tell at any point in time that a certain node is unavailable, or that a particular connection between any two nodes has gone down. This means that unlike a centralized system, a decentralized collaboration system must be able to tolerate temporarily inconsistent information, and automatically recover and resynchronize when the node or critical connection comes back up.

There is a substantial amount of art on the subject of data replication. Much of that art defines “replication” as the art of copying information from one location, and re-creating it at another location. In the present invention, however, the term “replication” is used in connection with “integration”, and “synchronization”, thereby enabling a distributed system in which information is not only replicated from one location to one or more others, but also kept in sync over time in spite of continuing updates, and which is integrated and related to with other information available at other nodes. On that latter subject, which is the topic of the present invention, far less prior art exists.

Further, most art on the subject of replication and synchronization addresses only the requirements replicating and synchronizing files, trees of files (e.g. directories) and relational databases. The present invention, however, addresses the requirements of replicating, integrating and synchronizing fine-grained, related pieces of shared information such as entity objects and relationship objects governed by a configurable (and often application-dependent) and even dynamically discoverage information model, which is a substantially harder problem, in particular when applied to a scenario where nodes only hold a portion of the pieces of shared information.

For example, Shaheen et al disclose a “System and method for maintaining replicated data coherency in a data processing system” (U.S. Pat. No. 5,434,994), in which all of the shared information is replicated between two or more servers, and where the shared information may be updated by either server, using a “reconciliation” algorithm upon the occurrence of specific events. Unlike the present invention, the sharing of information is not governed by an information model, there is no distributed locking, partially-replicated scenarios are not supported, there is no support for relating pieces of shared information, there is no provision for leases, there is no home replica, among others.

Neeman et al disclose a “Replication facility” (U.S. Pat. No. 5,588,147) for the “replication of files or portions of files” (implying that any file is only shared as a whole or not at all) and “any subtree of the distributed environment”, employing “multi-mastered, weakly consistent replication”. Unlike the present invention, Neeman et only support the (implicit) information model of directories and files, the files being contained by directories, and directories being contained by other directories. Further, there is no support for relating pieces of shared information, they do not provide distributed locking, nor partially-replicated scenarios, nor is there a provision for leases, among others.

Jones et al disclose “Synchronization and replication of object databases” (U.S. Pat. No. 5,684,984) which “provides a method of synchronizing information between a plurality of sites and a central location”. Unlike the present invention, Jones et al do not provide a symmetrical protocol, do not provide a uniform method of sharing pieces of information independent of the kind of information, the sharing of information is not governed by an information model, there is no support for relating pieces of shared information, there is no provision for distributed locking or leases, among others.

Gehani et al disclose “Maintaining consistency of database replicas” (U.S. Pat. No. 5,765,171) which is a method to efficiently detect the need for propagating changes that were made to a piece of shared information at a first node to all other nodes. Unlike the present invention, Gehani et al does not address the needs of heterogeneous collaboration, does not support a partially-replicated scenario, there is no provision for leases, there is no home replica, there is no distributed locking, among others.

Raman et al disclose “Replication optimization system and method” (U.S. Pat. No. 6,049,809), introducing the concept of cursors in the context of a weakly-consistent system. Unlike the present invention, Rama et al does not provide for an information model governing the sharing of information, does not address the needs of related pieces of shared information, does not provide for distributed locking, nor leases, there is no support for relating pieces of shared information, and does not address the needs of the partially-replicated scenario, among others.

Chan et al disclose “Method, system and computer program for replicating data in a distributed computed (sic) environment” (U.S. Pat. No. 6,338,092) where one or more nodes of the distributed system act as hubs, brokering updates to the shared information in a hub-and-spoke arrangement. Unlike the present invention, Chan et al do not support relating pieces of shared information, the sharing of information is not governed by an information model, there is no provision for distributed locking, nor for leases, and they do not disclose a symmetrical protocol, among others.

Zondervan et al disclose “System and method for synchronizing data in multiple databases” (U.S. Pat. No. 6,516,327). Unlike the present invention, Zondervan et al does not address the partially-replicated scenario, does not address the requirements of supporting relating pieces of shared information, does not provide a symmetrical protocol, does not provide distributed locking, and does not provide leases, among others.

Richardson et al teach a “Method and apparatus for maintaining consistency of a shared space across multiple endpoints in a peer-to-peer collaborative computer system” (U.S. Patent application 20040083263), and Ozzie and Ozzie teach a “Method and apparatus for designating endpoints in a collaborative computer system to facilitate maintaining data consistency” (U.S. Patent application 20040024820), both of which assume that all shared information is represented as a number of unrelated, potentially structured files (such as XML files), which may be modified concurrently by the collaboration participants without protection against conflicting modifications, and describe how these concurrent modifications can be serialized and the temporarily conflicting copies of the shared information can be made to converge, given certain assumptions about the modifications. However, the shared information in the present invention is assumed to be a collection of related pieces of information, each of which is atomic, such as entity objects, relationship objects and their properties, whose sharing is governed by an information model. Further, they do not provide support for relating pieces of shared information, there is no distributed locking, they do not provide for leases, there is no home replica, among others.

Hirashima et al disclose a “Replication Method” (U.S. Pat. No. 6,301,589) for the replication of directory data, and the reconstruction of directory data from backups in case the data “has been lost owing to, for example physical damage of a magnetic disk” and others. The present invention, however, among others, discloses a replication method between multiple active nodes in a distributed system (as opposed to the backup scenario) that enables replicated information to evolve over time, keeping all replicas on all the nodes coherent, and allowing updates from any node with a replica, subject to having obtained the lock. Further, the present invention governs the sharing of information by an information model, supports relating pieces of shared information, and employs the concept of leases, which Hirashima does not.

Van Huben et al disclose “Methods for shared data management in a pervasive computing environment” (U.S. Pat. No. 6,327,594) which provides a “common access method [and protocol]. . . to enable disparate pervasive computing devices to interact with centralized data management systems”, focusing on the problem of how to include information collected by the pervasive computing device in a larger data management system, without requiring the pervasive computing device to be a full-fledged computing system. The present invention, however, and among others, discloses a general-purpose method and system to replicate information generated and modified any of a number of peer nodes to the others, thereby achieving real-time coherence. Van Huben further does not disclose an information model, a node, a protocol, leases and many other aspects of the present invention.

Thus, it is desirable to provide a system and method for replicating, integrating and synchronizing distributed information that facilitates the operation of any decentralized system sharing information and it is to this end that the present invention is directed.

### SUMMARY OF THE INVENTION

An extensible protocol to replicate, integrate and synchronize distributed information (called X-PRISO™) as well as a system and a method employing it are described that allow an unlimited number of nodes on a network (e.g. the wired or wireless internet, any other type of wired or wireless wide-area, local-area or personal area network, or any hybrid) to participate in a distributed collaboration with some or all collaboration-related information shared, related, integrated and synchronized between some or all of the participating nodes. The protocol in accordance with the invention may be implemented as software code being executed by the nodes of a distributed collaboration system wherein each node is implemented as a computing resource connected together by a network. In alternate embodiments, the protocol may be implemented through dedicated computing software, or dedicated computing hardware. In another alternate embodiment, the protocol may be implemented by a group of individuals connected together through the postal mail, speech, or any other communication channel. Any and all combinations and hybrids are possible.

The protocol uses non-reliable message passing, and is thus resilient in the face of non-reliable nodes and communication links. The software or other implementation technology that implements the protocol for such a distributed collaboration system is also described.

In more detail, X-PRISO is a fully symmetrical protocol, i.e. all nodes communicating using X-PRISO can send and receive messages in the same format; there need not be any distinction between requesting and responding messages. This type of symmetrical protocol is often described as a peer-to-peer web services protocol. However, in spite of being fully symmetrical, X-PRISO does not imply that all participating nodes in the distributed collaboration system must be of the same type. They may be of the same type, or may have been constructed entirely independently by different developers in different organizations employing different technology; any combination of nodes may come together at will, as long as they all agree on conforming to the X-PRISO protocol and a core information model for the information they wish to share. Because of that, X-PRISO goes beyond being “only” a protocol that can be used to construct distributed collaboration systems. It can also be used to allow different systems of many types to share information, and thus to join together into a larger, heterogeneous, distributed system that supports (human, non-human, and hybrid) collaboration in the wider sense. In particular, it can be used to allow software to collaborate.

FIG. 5 shows one embodiment of the invention: Collaboration participant 501 a may run a node 503a on a PC, collaboration participants 501b may use browsers running against node 503b and 503c, implemented as part of a server-side web application, collaboration participants 501c are non-human software agents running a dedicated node 503d and within a server node 503c, respectively, and collaboration participant 501d runs a node 503e a mobile device. They all interact with all or parts of the shared information 502 through a variety of nodes, potentially implemented by and distributed by a variety of vendors, all conforming to X-PRISO.

For example, a web-based, client-server collaboration system can interoperate with a desktop-based, peer-to-peer collaboration system through X-PRISO. Heterogeneous, collaborative software from different vendors can interoperate by agreeing to X-PRISO. Collaborative software of one vendor can communicate with and collaborate with other types of information systems, and vice versa. Users can use their collaborative system of choice to access shared information and communicate and collaborate with their colleagues and machines. Companies can provide collaboration support across their value chains, by X-PRISO-enabling all of their software packages that are touched by collaborative business processes. As X-PRISO can be implemented in any technology that supports the sending of structured messages (e.g. web services, remote procedure calls and others), and because X-PRISO can share any type of information, X-PRISO provides a general-purpose avenue to make any combination of server-based, desktop-based, and mobile device-based information systems interoperate that need to share information of some kind.

### BRIEF DESCRIPTION OF THE DRAWINGS

FIG. 1 is a diagram illustrating the sharing of information;

FIG. 2 is a diagram illustrating a single centralized copy of the shared information in a typical centralized collaboration system;

FIG. 3 is a diagram illustrating a decentralized architecture for sharing information in which each node holds a copy of the shared information;

FIG. 4 is a diagram illustrating a decentralized architecture for sharing information in which each node does not hold a complete copy of the information;

FIG. 5 is a diagram illustrating a decentralized architecture for sharing information in accordance with the invention;

FIG. 6 shows a simple example information model in accordance with the invention;

FIG. 7 illustrates an example of objects that were instantiated according to the information model shown in FIG. 6;

FIG. 8 illustrates a method in accordance with the invention for partitioning an Object Graph for the purpose of replication; and

FIG. 9 is a diagram illustrating an example architecture of an X-PRISO node in accordance with the invention.

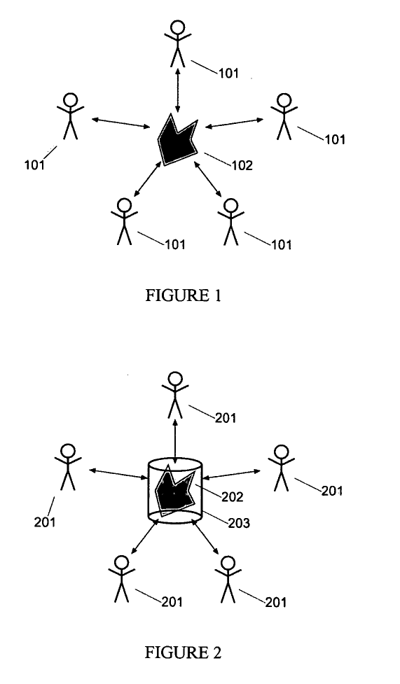

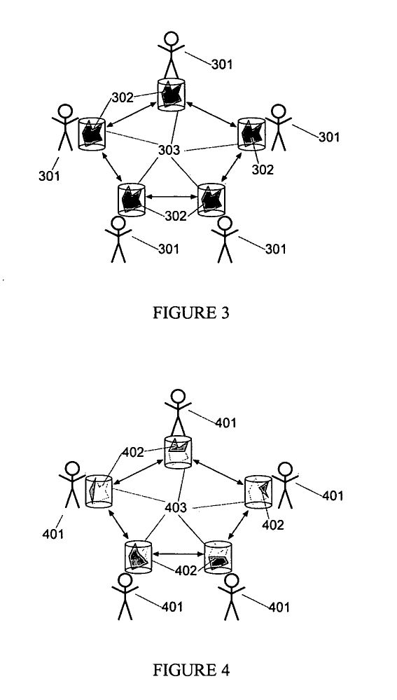

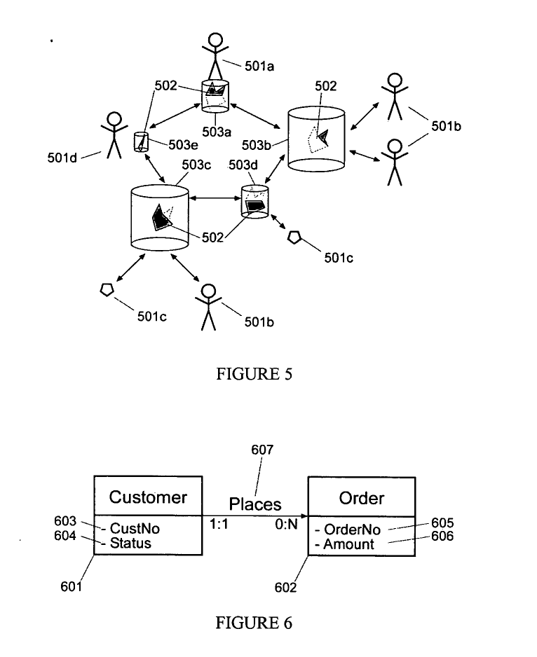

### DETAILED DESCRIPTION OF A PREFERRED EMBODIMENT

The present invention is particularly applicable to a collaborative distributed computer system (e.g., employing a client-server, peer-to-peer, or hybrid architecture in whole or in part) and it is in this context that the invention will be described. It will be appreciated, however, that the system and method in accordance with the invention has greater utility since it may be used with various other computer system architectures, social architectures and hybrid architectures in which it is desirable to provide collaboration or the sharing of information in a distributed, decentralized system.

Architectural Assertions

The following assertions can be made about a Distributed System according to the present invention:
The pieces of information to be shared are called objects.
It is not required that there is a single Node in the Distributed System that has full and complete knowledge of all the shared information in the Distributed System. We do not exclude that possibility—the present invention supports full centralization as a special case—but we do not require it either. A Distributed System according to the present invention will work if it is fully decentralized, partially decentralized, or fully centralized in whole or in part, thereby allowing all possible centralization/decentralization styles. Among other benefits, this means that the present invention supports collaboration scenarios (common in multi-organization collaborations for confidentiality and security reasons) where no one user, or company, or technical system (such as a software system), has access to all shared information subject to collaborative activities.
It is not required that there is at least one Object that is replicated to all of the participating Nodes. While that may often be desirable in real-world uses of the System (e.g. to have at least a common “start” object in a collaborative space), this would be an application choice and is not required by the present invention.
It is not required that the set of participating Nodes be fixed during operation of the Distributed System. Neither is it necessary to pre-determine a maximum number of Nodes for the Distributed System. During operation of the Distributed System, Nodes may enter and leave the Distributed System, either temporarily or permanently. The duration of operation of the Distributed System is potentially unlimited. It is possible that after some period of operation of the System, none of the originally participating Nodes will still be participating.
The transport layer used to send X-PRISO Messages from one Node to another may be lossy, but it needs to guarantee that Messages arrive either fully intact or not at all. This requirement can be met in a variety of ways, such as by any transport that uses a technique such as calculating a sufficiently strong check-sum on all Messages, and discarding all Messages where a check-sum error is detected.
It is assumed that most Messages sent by the same sending Node to the same receiving Node are received in the same order as they were sent. The term “most” here means that operational efficiency of the Distributed System degrades as the number of out-of-order Messages increases.
Receiving Nodes must tolerate incoming Messages that are out of order. Receiving Nodes must tolerate and discard duplicates of incoming Messages.
It is assumed that the network is fully routable, i.e. that any sending Node can send a Message to any other destination Node as long as one of the destination Node's Node Identifiers (such as a network address) is known. Today's IPv4 network is not fully routable on an IP level because of the widespread use of firewalls and Network Address Translation. However, the IPv4 network can be (and is being) made fully routable, for example through suitable overlay networks such as today's Instant Messaging networks, e-mail networks etc. with addressing schemes on a higher level than IP addresses. Full routing can also be accomplished through IPv6, and a number of other techniques. As the present invention does not require “quick” or real-time Message delivery, a “slow” network such as today's e-mail network (that may involve multiple SMTP and POP hops including polling, for example) and even a network requiring human intervention (e.g. the postal mail system) can be used as a transport for X-PRISO, as long as the application scenario can tolerate the delay inherent in the slow network.
It is assumed that no Node in the Distributed System is hostile and that all Nodes implement X-PRISO correctly. Preventing the participation of a hostile Node can be accomplished, for example, by requiring any new Node wishing to participate to authenticate itself against a “white list”, held by each Node, before any of its messages are accepted. The present invention can be used with many such authentication schemes. The present invention can also be used with a range of higher-level protocols, which, for example, can take the specific pieces of information to be shared into account, and use those to determine the most suitable security policy. X-PRISO can even be used for the real-time sharing of evolving security information in parallel and integrated with the semantic information (i.e. the actual information to be shared for the purposes of the collaboration) through Relationships that express the “semantic information is governed by security information” semantics: through the shared security information (instances of a security information model) a Node can thus to determine under which circumstances it should give up a Lock for a semantic object, which Leases it should renew and when etc. Because the security information is shared through X-PRISO, this enables an efficient and cost-effective way of allowing Nodes to agree on the same security policy for shared Objects.
Objects are always fully replicated and synchronized; a situation in which, for example, only some of the Properties of an Object have been replicated or synchronized while some other Properties are out of date is not allowed to exist: Nodes must guarantee the atomicity of transactions through appropriate measures. (But note the section below on complete and incomplete Object Graphs.)
All Replicas of a given Object within the Distributed System share exactly one Lock; i.e. exactly one of the Replicas of a certain Object may be updated at any point in time, while all other Replicas of the same Object may not perform any updates unless they acquire the Lock first from the Replica that currently holds the Lock (which, by surrendering the Lock, loses the right to perform further updates before potentially re-acquiring the Lock). As the present invention is typically used with fine-grained Entity and Relationship Objects (rather than big, opaque “blob” data such as a files), application-level requirements for concurrent modification and successive reconciliation and merging of shared information (e.g. for concurrent document editing in models such as the model of the Concurrent Versioning System CVS) can, in most cases, simply be met by representing the application-level information (such as a file) as a graph of (many) Entity and Relationship Objects, some of whose Replicas with the Lock are held by other Nodes: if different Nodes update different Entity or Relationship Objects in the object graph that represents the application-level information (such as a file), no conflict will occur. In one embodiment of the present invention, such fine-grained representation of coarse-grained information (e.g. files) is provided through a virtual file system (e.g. a WebDAV or other virtual file system) that, when read by client software that expects files as input, assembles the fine-grained information representation into a file dynamically and that, when written back to the virtual file system by the client software, parses the file provided by the client software into a fine-grained representation on the fly. Such parsing and generating is straightforward to those skilled in the art.
Where true concurrent editing and related capabilities such as versions, revisions, configurations, and other version control and configuration management capabilities are required for fine-grained Entity and Relationship Objects by an application of the present invention, the application's underlying information model needs to represent this. When a new concurrently-modifyable copy of a semantic object shall be created, the System creates one or more appropriate Objects that represent this. They are reconciled or merged by an update to the original Objects, either deleting or retaining (for historical purposes) the previously created copies, according to an application-specific reconciliation or merging process (which may or may not require human intervention). The present invention can be used with many information models supporting this case; those skilled in the art will know how to create and use such information models for this purpose.
   Architecture

Node Identifiers

Each Node in the Distributed System carries a unique identity. This Node identity is expressed through one or more Node Identifiers, each of which represents the Node's unique address in a particular addressing scheme.

For example, a Node A may be identified as:
http://someplace.net/node1 (accessible by sending a Message using HTTP POST at this URL)
mailto:someone@someplace.net (accessible by sending a Message using e-mail)
xmpp:someone@someplace.net/node1 (accessible by sending a Message over the XMPP protocol)
a postal address (accessible by sending a Message written on a piece of paper through the postal service)

If a Node B wishes to send a Message to Node A, and if Node B knows more than one address for Node A, Node B can choose which address—and thus transport—to use. How to choose one address over the other is completely up to Node B (e.g. the “fastest” transport, the most reliable, etc.).

As Nodes must tolerate duplicate incoming Messages and discard any received duplicates, Node B may also send the same Message to more than one, or even all of Node A's known addresses, potentially employing more than one transport. Due to the typically unnecessary network traffic that this generates, and the associated additional computational load, this behavior is discouraged except in those circumstances where Node B considers it highly likely that sent Messages will get lost or unpredictably delayed.

X-PRISO can run across any transport that meets the requirements outlined above.

Information Model

Overview

Information modeling (also known as entity-relationship-attribute modeling, or class-association-attribute modeling, “static” modeling or modeling using the concept of an ontology) has been accepted industry practice as a technique for defining the structure and semi-formal semantics of information for a considerable length of time. It is known to be able to represent any kind of information, whether that information is fully structured, unstructured, or semi-structured. (In the unstructured case, only one entity of the information model may ever be instantiated, with a substantial amount of data carried by one of its properties.) As the present invention addresses the problem of information sharing where the shared information is a collection of related pieces of information, information modeling is particularly suited as a technique for making assertions about the shared information at the boundary between nodes.

Information to be shared through X-PRISO is best understood by assuming that it has been modeled using a simple extended entity-relationship-attribute modeling technique. All major traditional and modern information modeling techniques (e.g. the basic class-association-attribute modeling technique provided by the Unified Modeling Language UML) can easily be mapped onto the X-PRISO information modeling technique by those skilled in the art as X-PRISO imposes few restrictions on its own. X-PRISO's information modeling technique is defined for the purpose of being able to describe the rules of the X-PRISO protocol and participating Nodes; there is no requirement that systems according to the present invention represent the information they manage through X-PRISO's information modeling technique; only that they follow the rules described in terms of X-PRISO's information modeling technique. While in the preferred embodiment nodes represent shared information internally according to the information model as well, this is generally not the case for heterogeneous distributed systems.

In addition, information to be shared through X-PRISO can also be modeled in a hierarchical fashion (such as through XML document type definitions or schemas that assume a hierarchical structure of information). In this case, the hierarchy is assumed to be an instance of an information model that can capture such a node hierarchy through a suitable “node” entity and a “child” relationship with appropriate properties.

The X-PRISO information modeling technique recognizes three major concepts: Entity, Relationship, and Property. If an assertion is true regardless of whether it is about an Entity or a Relationship, we may use the term “Object” instead of the phrase “Entity or Relationship”.

Relationships are always binary. (N-ary Relationships can be represented as associative Entities in the X-PRISO information model.) Both Entities and Relationships can carry Properties (defined further below). As the X-PRISO information modeling technique is only used for information modeling and not behavioral modeling, the concepts of operations or methods are irrelevant for Entities or Relationships and thus not further defined. There is nothing in X-PRISO that prevents the use of single or multiple inheritance for information modeling, both for Entities and Relationships, with or without complex disambiguation and/or overriding rules for Properties in the subtypes.

Each Entity is a direct instance of exactly one EntityType (and an indirect instance of all EntityTypes that are the supertypes of the EntityType that the Entity is a direct instance of). For example, Entity “Joe Smith” could be a direct instance of EntityType “Customer” (and an indirect instance of EntityType “EconomicActor”, if “EconomicActor” is a supertype of “Customer”).

Each Relationship is a direct instance of exactly one RelationshipType (and an indirect instance of all RelationshipTypes that are the supertypes of the RelationshipType that the Relationship is a direct instance of). The RelationshipType defines which EntityTypes may be instantiated as sources and destinations of the RelationshipType's instances, and minimum and maximum Multiplicities for their participation. For example, Relationship “Joe Smith places Green Porsche Order” could be a direct instance of RelationshipType “Customer.Places.Order”. This RelationshipType could restrict the source ends of instances of RelationshipType “Customer.Places.Order” to Entities of EntityType “Customer” and the destination to Entities of EntityType “Order” with multiplicities of 0:1 and 0:N, i.e. no more than one Customer per Order, and any number of Orders per Customer.

In an alternate embodiment, the X-PRISO information modeling technique also supports a looser interpretation of the concept of a Relationship that not only allows Entities as sources or destinations of Relationships, but Relationships as well. During the remainder of this document, we assume for readability reasons that sources and destinations of Relationships may only be Entities, as this is the most common case. However, as it will be apparent to those skilled in the art, there is nothing in the present invention that prevents the use of Relationships as sources and destinations of other Relationships, and those skilled in the art will be able to apply the present invention to those scenarios.

Each Property is defined by a PropertyType. The PropertyType defines the identity of a Property within an Object, so the Object's Properties can be distinguished. It also defines a data type for the Property, such as integer or string. Properties carry atomic information, i.e. information that is not further broken into constituent pieces for the purposes of information sharing; examples for atomic information are the number 5, the string ‘X-PRISO’, or a bitmap image that is only shared as a whole or not at all.

The present invention can be used with any data type for PropertyTypes (supported in a serialized XML message syntax, for example, by using new elements in a different XML namespace where instances of those data types need to be inserted). The present invention also does not prescribe a serialization format for instances of those data types, except that all Nodes in the Distributed System must agree on the same serialization format. Thus, the present invention allows substantial latitude in the types of information that can be supported.

Each EntityType, RelationshipType, and PropertyType has a permanent unique identifier that constitutes its respective identity (i.e. the identity of the type, as opposed to the identity of the instance). During operation of the Distributed System, all EntityTypes, RelationshipTypes and PropertyTypes are identified by their unique identifiers. All Nodes in the Distributed System must agree on those identifiers, and the underlying information model during the operation of the Distributed System.

As soon as a unique identifier is assigned to an EntityType, RelationshipType, or PropertyType, this EntityType, RelationshipType, or PropertyType is considered “frozen” and may not be changed any further. If a new version of an EntityType, RelationshipType, or PropertyType is created, it must carry a different unique identifier. Any of a number of the well-known mechanisms for schema evolution can be used together with X-PRISO as long as this basic rule is not violated.

By convention, all identifiers for EntityTypes, RelationshipTypes, and PropertyType start with the reverse internet domain name of the organization or individual that defined the type. In order to facilitate a high degree of semantic interoperability between X-PRISO-enabled Nodes, X-PRISO implementers are encouraged to re-use the identifiers of EntityTypes, RelationshipTypes and PropertyTypes that other implementers have defined already to express common semantics.

All Nodes exchanging Messages that contain an identifier to such an EntityType, RelationshipType, or PropertyType are assumed to be aware of the information model and its definitions that provides the EntityType, RelationshipType, or PropertyType identified by the identifier. X-PRISO itself does not define a mechanism for distributing the information model among Nodes. Such a mechanism is assumed to exist “out of band”. For example, all Nodes in a Distributed System may have the same information model hard-coded by virtue of their construction; or, they might have a way of automatically retrieving it from other Nodes of the Distributed System or an information model distribution facility on the internet via standard or non-standard protocols, either prior to commencing operations of the Distributed System, or on-demand during the operations of the Distributed System, such as when a Node A is being told about an Object X that makes use of a concept in the information model that is not known to Node A yet.

In an alternate embodiment called “X-PRISO on multiple meta-levels”, the Distributed System uses X-PRISO itself to distribute the information model: in this case, the Nodes of the Distributed System agree on a basic meta information model through a bootstrap mechanism such as hard coding, for example, and as a first step during operation of the Distributed System, exchange the information model as instances of this meta information model through X-PRISO. Once the information model has been propagated to all Nodes that need it, the Distributed System considers the information model “frozen” and regular operation begins, during which information is shared through X-PRISO that is an instance of the previously exchanged information model. This scheme may be applied recursively on as many meta-levels as desired.

In an alternate embodiment of “X-PRISO on multiple meta-levels”, the Distributed System shares the information model through X-PRISO concurrently with sharing the information; care needs to be taken not to violate the rule about immutability of unique identifiers and thus only a subset of X-PRISO's functionality is used for the exchange of the information model through X-PRISO. However, this alternate embodiment allows Nodes to augment the information model used by the Distributed System at run-time, which is particularly important when new Nodes join the Distributed System after the initial operation commenced, and if those new Nodes desire to augment the then-current information model. In particular, in this embodiment, Nodes may decide to only acquire knowledge of certain parts of the information model when they actually need it. For example, if a Node A receives an incoming Message from a Node B that contains or refers to an Object X of EntityType or RelationshipType T, and if Node A at that time does not know about T, Node A may use X-PRISO on the higher meta-level to first acquire knowledge about T from another Node (which may or may not be Node B), and then process the incoming Message.

Care must be taken not to confuse Messages that may look similar but that refer to information on different meta-levels. This alternate embodiment of “X-PRISO on multiple meta-levels” is best thought of as two distributed systems, whose nodes are joined one-to-one, and where one node of each pair of nodes is responsible for sharing the information model, and the other node is responsible for sharing the instances of the concurrently-shared information model.

Code Generator

In the preferred embodiment, the programming level definitions to represent the shared information according to the information model are generated through a code generator for the Java programming language. However, those skilled in the art understand that a generator for any other programming language, or for a data representation language (e.g. SQL or XML Schema, or OWL, or UML, or others), graphical or not, could also be used without deviating from the principles and the spirit of the invention.

For each of the EntityTypes in the information model, the code generator generates a Java class with the same name as the name of the EntityType, subject to character set translation rules from the naming character set to the Java identifier naming character set. For each of the RelationshipTypes in the information model, the code generator generates a Java class with the same name as the name of the RelationshipType, prefixed with the name of the source EntityType and a special separation character, and postfixed with the name of the destination EntityType and a special separation character, subject to character set translation rules from the naming character set to the Java identifier naming character set. For each of the PropertyTypes, the code generator generates, within the scope of the class representing the enclosing EntityType or RelationshipType, a “bound” Java Bean property with the same name (subject to character set translation rules from the naming character set to the Java identifier naming character set), i.e. it has setter and getter methods, and causes PropertyChangeEvents to be sent when its value changes.

Assuming that the underscore is the special separation character, the code generator also generates “bound” Java Bean properties called “_Source” and “_Destination” in each class representing a RelationshipType.

Through the code generator, the laborious manual coding of the information representation is avoided at any Node that chooses to internally represent the shared information according to the information model. Further, the code generator can be invoked during operation of the Distributed System whenever a Node encounters a new EntityType, RelationshipType or PropertyType for which it does not have a programming-language representation yet. Modern programming languages such as a Java have mechanisms to compile or interpret new code (in this case, code generated by the code generator), and to add that compiled or interpreted code at run-time to a running Node. Through these mechanisms, the Node can represent newly encountered information of a newly encountered type as well as information of a type that was known at construction time of the Distributed System.

In an alternate embodiment supporting multiple inheritance in the information model, the code generator generates a Java interface for each EntityType and for each RelationshipType, and uses interface inheritance to represent the multiple inheritance in the information model. In addition, it generates a Java class implementing the interface for each EntityType and RelationshipType for which direct instances may exist (i.e. those EntityTypes and RelationshipTypes that are not abstract); it is that Java class that is instantiated when an Object of the corresponding EntityType or RelationshipType is instantiated.

### EXAMPLE

FIG. 6 shows an example for an information model, using an UML-like graphical syntax, that serves as an example to illustrate the workings of the present invention. However, as it will be apparent to those skilled in the art, any other, simple or complex information model can be used with the present invention. This example is a very simple information model with two EntityTypes: Customer 601 and Order 602. They have PropertyTypes (CustNo 603 and Status 604 for the Customer EntityType and OrderNo 605 and Amount 606 for the Order EntityType), and are related by a RelationshipType called Places 607, expressing the fact that Customers place Orders, that there may be any number of Orders per Customer (Multiplicity 0:N), but that Orders are always placed by exactly one Customer (Multiplicity 1:1).

The showed EntityTypes and RelationshipTypes could have the following, permanent unique identifiers, assuming that the owner of the example.com domain defined them. As those skilled in the art with readily recognize, any other convention for assigning permanent unique identifiers could have been used without deviating from the principles and spirit of the invention.

| | | |
|---|---|---|
| Customer | EntityType | com.example.mm.CRM_v1_0#Customer |
| CustNo | PropertyType | com.example.mm.CRM_v1_0#Customer/CustNo |
| Status | PropertyType | com.example.mm.CRM_v1_0#Customer/Status |
| Order | EntityType | com.example.mm.CRM_v1_0#Order |
| OrderNo | PropertyType | com.example.mm.CRM_v1_0#Order/OrderNo |
| Amount | PropertyType | com.example.mm.CRM_v1_0#Order/Amount |
| Places | RelationshipType | com.example.mm.CRM_v1_0#Customer_Places_Order |

Objects: Instances of the Information Model

In a distributed system where the sharing of information is governed by the information model shown in FIG. 6, one or more of the participating Nodes may instantiate all or parts of the information model. Each of the instances carries a permanent unique identifier that establishes the identity of the Object.

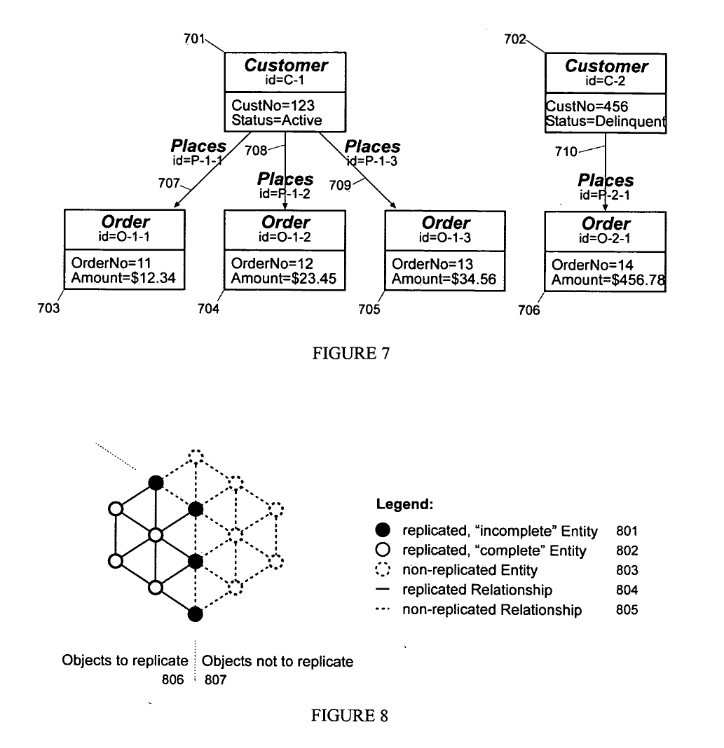

For example, Node A may instantiate the following Objects, shown graphically in FIG. 7:
An Entity 701 of EntityType Customer with identity=C-1, Property CustNo=123, and Property Status=Active
An Entity 702 of EntityType Customer with identity=C-2, Property CustNo=456, and Property Status=Delinquent
An Entity 703 of EntityType Order with identity=O-1-1, Property OrderNo=11, and Property Amount=$12.34
An Entity 704 of EntityType Order with identity=O-1-2, Property OrderNo=12, and Property Amount=$23.45
An Entity 705 of EntityType Order with identity=O-1-3, Property OrderNo=13, and Property Amount=$34.56
An Entity 706 of EntityType Order with identity=O-2-1, Property OrderNo=14, and Property Amount=$456.78
A Relationship 707 of RelationshipType Places with identity=P-1-1, source=C-1 (first customer), destination=O-1-1 (first order)
A Relationship 708 of RelationshipType Places with identity-P-1-2, source=C-1 (first customer), destination=O-1-2 (second order)
A Relationship 709 of RelationshipType Places with identity-P-1-3, source=C-1 (first customer), destination=O-1-3 (third order)
A Relationship 710 of RelationshipType Places with identity=P-2-1, source=C-2 (second customer), destination=O-2-1 (fourth order)

The actual identifiers can be any string that is guaranteed to be unique so that the invention is not limited to any particular type of unique identification generation or coding scheme. By convention, any Node semantically instantiating an Object (as opposed to replicating it, in which case it must use the identifier already assigned to this Object by the Node that semantically instantiated the Object), creates a new Object Identifier that starts with one of the Node's Identifiers and appends a locally unique relative identifier. This convention prevents unexpected name collisions. (Note: In the example currently being discussed, we deviate from this convention in order to show short and human-readable character strings for purposes of readability of this example, although they do not follow the convention. Note that the present invention only requires uniqueness, but does not require a particular mechanism of guaranteeing uniqueness.)

If the instances in this example were used as the shared information in a Distributed System, X-PRISO would be used to synchronize Replicas of some or all of those Objects among the participating Nodes. The basic idea behind X-PRISO is that if some of those Objects were originally created on a Node A, a Node B could request some or all of those Objects and then replicate some or all of them. Node B could also create additional Objects and relate them to the Objects originally created at Node A. While possessing the Lock (such as after acquiring it from the Node currently holding it), either of them could make modifications that would then be forwarded to the other Nodes. The Nodes use the Object's identifiers to identify the Objects to each other in the messages they exchange with each other. This is described in detail below.

Object Replication

If a Node B wishes to obtain a Replica of Object X a Replica of which is currently available at Node A, Node B sends a Message to Node A requesting a Replica of Object X. Node B identifies Object X by providing Object X's unique identifier.

If Node A wishes to meet the request, Node A responds to Node B with a serialized copy of Object X. Once Node B has received the Message, it can reconstruct a full Replica of Object X. This Replica is subject to a Lease, as discussed below.

Access Paths

Sometimes, a Node C would like to obtain a Replica of Object X from Node B, but Node B does not actually have a Replica of that Object X; however, it may be that Node A has a Replica of Object X. If Node C wants to obtain a Replica of Object X from Node A via Node B, then it needs to have the ability to specify that access path.

This access path consists of a sequence of Node Identifiers that specifies the path through which the Object X should be accessed. Node identifiers are described in section “Node Identifiers”.

Complete and Incomplete Object Graphs

When a Node B requests one or more Replicas from Node A, Node B does not typically want to obtain Replicas of all Replicas that Node A holds at any point in time (sometimes it might, but in many cases it does not). Thus, a mechanism needs to exist that allows Node A to virtually partition the Object Graph present at Node A (that is defined as the graph whose nodes are the replicas of entity objects present at Node A, and whose edges are the replicas of relationship objects present at Node A) into two partitions, in order to be able to respond to a particular replication request: one partition contains the Objects will be replicated to Node B, and one partition contains those Objects that will not be replicated.

Note that partitioning the Object Graph for this purpose only determines which Objects will be replicated to another Node; it does not impact the semantics of the shared information, only the replication structure. This partitioning needs to be performed in a way so that Node B does not obtain “dangling” references, but still can determine how to complete the Object Graph with future requests to Node A (see below).

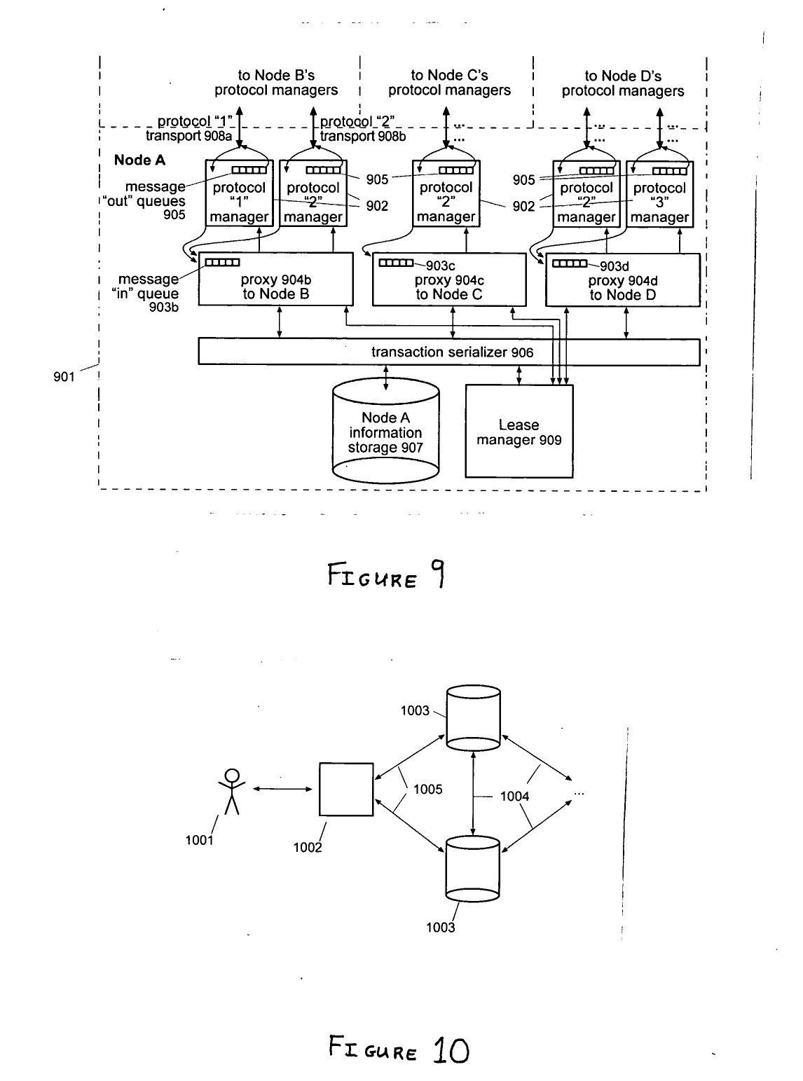

This partitioning method is illustrated in FIG. 8. Here, the Objects to replicate 806 are shown on the left side of the dotted line, while the Objects not to replicate 807 are shown on the right side. The non-filled circles 802 represent “complete” Entities (see description below), and the filled circles 801 represent “incomplete” Entities (see description below). The dotted circles 803 represent Entities that exist at Node A, but that are not replicated. Solid lines 804 represent Relationships that are replicated, while dotted lines 805 represent Relationships that are not replicated. Together, all circles and lines, regardless of the graphical style used in FIG. 8, represent the Object Graph for this example.

The partitioning constraints are as follows:
In general, if a Node A has or obtains a Replica of Relationship X with source Entity Y and destination Entity Z, Node A also must have a Replica each of Entities Y and Z. The general principle of the preferred embodiment of the present invention is that a Relationship never has a “dangling” source or destination, neither semantically nor in any of its Replicas. However, as those skilled in the art will recognize, this constraint on Replicas is not necessary for the successful operation of X-PRISO and an alternate embodiment of the present invention may allow “dangling” sources or destinations for Replicas.
We distinguish between “complete” and “incomplete” Entities at Node B. A “complete” Entity is one for which all associated Relationships are known at Node B that can and may be determined by Node B (for security and other reasons, other Nodes may not want to, or be able to, tell Node B about all associated Relationships present at all other Nodes). An “incomplete” Entity is one for which at least one associated Relationship, that could be known by Node B, may not be known because Node B has not attempted to determine it.

Note that the term “complete” and “incomplete” only refers to an Entity Replica's knowledge of associated Relationships at a certain Node at a certain point in time; it does not apply to an Object's Properties, which are always exchanged as a whole.
When Node A responds to a request from Node B, it sends the (explicitly, or implicitly—see section on Scope below) requested Entities in such a manner that allows Node B to determine from the Message which of the Entities is “complete”, and which is “incomplete”. (For example, the Message may contain two sections: one section contains all serialized “complete” Entities and one contains all serialized “incomplete” Entities that are needed to meet the request.) Typically, Node A sends the minimum set of serialized Objects needed to meet the request, but it may send more (see discussion on scope below).
In order for this to work, Node A needs to keep track of which Replicas Node B has received previously. The “completeness” or “incompleteness” of an Entity at Node B is determined by looking at both the previously granted Replicas, and the newly granted Replicas; Node A needs to take both into account when splitting the Entities into the “complete” and “incomplete” partitions.
Node A also sends a list of identities for Entities that it knows Node B has a Replica of, which, by virtue of the current Message, are now becoming “complete”, and a list of identities for Relationships that it knows Node B has a Replica of and that need to be consulted to construct the correct set of Relationships having an Entity as their source or destination that is becoming “complete”.

The “completeness” and “incompleteness” of Entities is shown in more detail in the example in the following section.

Scope

When a Node B requests a Replica of an Object X from Node A, it would be inefficient if Node A only returned the requested Replica of Object X in its response, and nothing else. This is because it is very likely that Node B will also be interested in the Objects directly related to Object X. However, because Node B, in most cases, does not know which Objects are related to Object X at the time of its request for Object X, and because Node B thus cannot directly request Leases for, X-PRISO supports the notion of a scope parameter for replication-related requests.

The scope parameter is an “advisory” parameter, i.e. it could be ignored by the receiver without compromising the protocol. Using the scope parameter, Node B can specify how many “steps”, from Object X, of Objects it would like to obtain Replicas of in response to its request. One “step” is defined as a traversal from an Entity X to all directly related Entities Y1 . . . YN (across Relationships R1 . . . RN where Ri's source (or destination) is X, and Ri's destination (or source) is Yi), or from a Relationship T to its source and destination Entities X and Y.

To use the example in FIG. 6 and FIG. 7, if Node B requested a Replica for the Object 705 with identifier O-1-3 (the third order of the first customer), the following Replicas should be serialized and transmitted if the following scope parameters were given and Node A literally obeyed the scope parameter:

| | | Is a complete/ |
|---|---|---|
| Scope | Replicated Objects | incomplete Entity |
| 0 | O-1-3 (third Order) | incomplete |
| 1 | O-1-3 (third Order) | complete |
| | P-1-3 (third Places Relationship) | n/a |
| | C-1 (first Customer) | incomplete |
| 2 and higher | O-1-3 (third Order) | complete |
| | P-1-3 (third Places Relationship) | n/a |
| | C-1 (first Customer) | complete |
| | P-1-1 (first Places Relationship) | n/a |
| | O-1-1 (first Order) | complete |
| | P-1-2 (second Places Relationship) | n/a |
| | O-1-2 (second Order) | complete |

Scope parameters should rarely be large numbers, as the number of Objects subject to the exchange typically grows very rapidly with increasing scope parameters. A good value for many applications is 2.

Through similar, but more complex mechanisms, more complex scope parameters can be specified. In an alternate embodiment, a Node B specifies that it requests a Replica of Entity X from Node A, and all Objects within a certain scope from Entity X, but only those that are related to Entity X by a set of certain RelationshipTypes, or that are of a certain EntityType, or that have certain values for its Properties, or any other criteria. (One example would be “only those Entities related to Entity X through a ‘hierarchical containment’ Relationship” as it is common when a hierarchical information model, such as XML's, is translated into an X-PRISO-compatible information model.)

Making “Incomplete” Entities “Complete”

When a Node B has obtained a Replica of Entity X from Node A, and this Replica is an “incomplete” Entity, Node B may request, at a later time, from Node A, to make this Replica “complete”. (The Replica may also become “complete” as a side effect of processing the response to another request for replication of a different Object, or as a side effect of processing the response to another request for making another Entity “complete”.)

For example, if Node B requested a Replica of Object O-1-3 (705) in the example above, specifying scope 1, it will have obtained a complete Replica of Entity O-1-3 (705), a Replica for Relationship P-1-3 (709), and an incomplete Replica of Object C-1 (701).

Now, Node B may want to determine the complete set of orders that the customer with identifier C-1 has placed. In other words, it needs to obtain Replicas of all Relationships that have C-1 (701) as a source (or destination), and Replicas of all Entities that are destinations (or sources) of those Relationships. (The latter is necessary to prevent dangling Relationships, which are prohibited in the preferred embodiment.) Consequently, X-PRISO provides a mechanism for a Node B to request that an “incomplete” Replica of an Entity X, obtained from Node A, be “completed”.

When Node B receives a (positive) response from Node A, this response will contain serialized Relationships of all Relationships that are still required to make Node B's “incomplete” Replica of Object X “complete”. Node A does not need to send those Relationships that Node B already knows about. In the example, Node B will then have Replicas of the Objects C-1 (701), O-1-1 (703), O-1-2 (704), O-1-3 (705), P-1-1 (707), P-1-2 (708), and P-1-3 (709). All Entity Replicas will then be complete. Note that because the Object Graph at Node A is disconnected, Objects 702, 706 and 710 will not be replicated or affected by the replication as discussed.

It may also be that a Node A sends a Message to Node B containing enough information so that Node B now has Replicas of all attached Relationships to an Entity X, while prior to the Message, Node B considered its Replica of Entity X to be “incomplete”. Unless Node A conveys to Node B that as a result of the Message, Node B's Replica of Entity X is now “complete”, Node B will still consider its Replica of Entity X to be “incomplete”. In order to convey this transition of a Replica from “incomplete” to “complete”, Node A sends a Message indicating that, identifying Entity X through its unique identifier.

Default Start Entity Identifier

In an alternate embodiment, each Node has one Entity that is well-known and that must be present at the Node for as long as the Node is operational. This Entity is called the Start Entity for that Node, and must have a (within the Distributed System) well-known identifier given the identifier or its Node, such as
<Node-id>#HO
where <Node-id> is the identifier of the Node.

In this embodiment, there is a requirement that all the Start Entities of all Nodes in the Distributed System participate in one connected Total Object Graph, and no Objects in the Total Object Graph are disconnected from the remainder of the Total Object Graph. In this embodiment, it is thus guaranteed that any Object can be reached by traversal of Entities and Relationships from the respective Start Entity of any of the Nodes in the Distributed System.

Behavioral Description

In this section, the behavior of Nodes communicating with each other through X-PRISO is described. For efficiency reasons, multiple requests and/or responses and/or other content from multiple operations may be packaged into the same Message. This requires more decoding effort on behalf of the receiver of the Message, but helps to reduce network traffic. This document discusses individual requests and responses for the purposes of readability.

Handshaking

Every Message between any Node A and any Node B carries a Message Identifier that uniquely identifies this particular Message within the scope (A;B), i.e. the ordered pair of Node A and Node B. The Message Identifier is an integer number. The first Message sent from any Node A to any Node B has Message Identifier 1, which can be encoded in a variety of ways—agreed upon between the Nodes—depending on the chosen Message syntax and the underlying transport mechanism that may provide for such a Message Identifier already. Further Messages sent by the same Node A to the same Node B increment the Message Identifier by one each.

Every Message sent by a Node A to a Node B also carries a list of Message Identifiers of Messages that Node A previously received from Node B and that Node A had not confirmed yet. When Node B receives this list of Message Identifiers from Node A, it thereby receives confirmation that Node A has indeed received the corresponding Messages previously. Before Node B receives such a confirmation of having received a certain Message, Node B has no way of knowing whether Node A actually received a previously sent Message, as X-PRISO does not require transports that guarantee Message delivery.

If one or more Messages from Node B to Node A are lost, sooner or later, Node A will receive a Message from Node B that has a Message Identifier that is too high based on its own count. In response, Node A will send a Message to Node B asking it to re-transmit all Messages starting with the Message Identifier that was the lowest Message Identifier that was missing.

The practical use of the confirmation list is that a Node can discard its record of the Messages that it sent as soon as they were confirmed, while it needs to keep a record of those that have not been confirmed yet, in order to be able to resend them if necessary. There is only one exception to this rule: Nodes generally must keep a copy of received Messages with Message Identifier 1; by comparing this stored Message with any incoming Message with the same Message Identifier 1, it can determine whether or not the incoming Message is a resend of the first Message, or whether the sending Node has erased its memory of previous interactions (e.g. because of a system crash)

Messages may be “empty” and as such, only contain Message confirmations but no other content. A Node may decide to send such an “empty” Message in order to confirm (for example a large number of) outstanding Messages, or in order to confirm a Message that has been outstanding for a long time, but is not required to do so. Nodes may also use such empty message as a “ping” to determine whether another Node is available. The “pinged” Node is encouraged to respond with a similar “ping”.

Disconnect and Shutdown Behavior

Occasionally a Node intends to shut down or become unavailable for a period of time, or indefinitely. While X-PRISO tolerates non-responsive Nodes, and—through expiration of Leases —Nodes eventually give up attempting to communicate with a non-responsive Node, it is generally a better idea for Nodes to announce that they will be unavailable than rather simply disappearing if they know that that is what will be happening.

Correspondingly, X-PRISO provides two mechanisms that allow a Node to announce to other Nodes that it will become unavailable: one indicates that it will be unavailable permanently, and the other that it will be unavailable for some period of time.

If a Node B receives a Message that Node A has become permanently unavailable, Node B must expire all Leases that it has obtained from Node A, and remove all other information that it holds about Node A as Node A will not come back.

If a Node B receives a Message that Node A has become temporarily unavailable for a period of time, it is recommended (but not mandated) that Node B keep back and hold all Messages that it otherwise would send to Node A during the period it is unavailable. If Node B receives a Message with a higher Message Identifier from Node A before the announced unavailability period is over, Node A is assumed to have come back up and Node B can continue to communicate with Node regularly, starting with the held-back Messages.

Holding back Messages during a period of known, temporary unavailability of a receiver Node A has an additional advantage: often, during this period, Node B can consolidate multiple Messages that would have gone out independently into one, thus reducing network traffic and processing requirements for Node A once it is available again. (A large number of incoming Messages at that time would likely overload Node A for some time after it has come back.) This consolidation can be performed both on the syntactic level (merging the content from several potential Messages into one) and on the semantic level: for example, if an Object X's Property P first changed from ‘value 1’ to ‘value 2’, and later to ‘value 3’ during the time period the receiving Node was unavailable, the sending Node may simply send a Property change from ‘value 1’ to ‘value 3’. In most application scenarios, there is no need to tell Node A about the intermediate ‘value 2’. Similarly, Node B does not need to tell Node A about Objects that were created and deleted again during the period Node A was unavailable.

Creating a new Replica by obtaining a Lease from another Replica Any Object X is initially created as the then only one Replica at exactly one Node (Node A). This Replica is called the Home Replica (and remains the Home Replica, unless the Home Replica is transferred as described below). In order to share this Object X with another Node (Node B), another Replica of Object X needs to be created at Node B. The process for doing so was already described above. However, the new Replica is always subject to a Lease, which has not been described yet.

In order to create this initial Lease, Node B sends a Message to Node A requesting a Lease for Object X as described above. Node B identifies the Object for which it requests the Lease (Object X) by specifying Object X's unique identifier. Node B also specifies for how long it would like the Lease for this Object to last.

Upon receiving the Message containing the replication request, Node A first checks whether it wants to and whether it is able to grant the replication request. If Node A grants the request, the next Message from Node A to Node B, confirming the request Message, will contain, at a minimum, a serialized form of Object X with all of its Properties. If Node A does not grant the Lease, the Message from Node A to Node B confirming the request Message (as described above) will not mention Object X, indicating that the request was denied.

Further, if Node A grants the request, Node A will assign Object X to an (existing, or newly created) LeaseGroup. The LeaseGroup may contain many Objects, all leased to the same Node B from the same Node A. It defines the duration of the Lease, and is the unit for which Lease extensions are requested, granted and/or denied. At any point in time, any number of LeaseGroups may be outstanding between any pair of Nodes. LeaseGroups are always specific to a ordered pair of Nodes. Each LeaseGroup has an identifier that is unique for the pair of Nodes A and Node B. The identifier is assigned by the Node granting the first Lease in the LeaseGroup, which establishes the LeaseGroup. Information about a LeaseGroup currently in effect is held by both Nodes participating in the LeaseGroup.

If previously, Node A has granted a Lease to Node B for a Replica of a different Object Y but within the same LeaseGroup, the fact that Node A specified a new expiration date for this LeaseGroup in any Message to Node B, causes the Lease for Object Y to be extended as well (even if the Message did not contain any reference to Object Y whatsoever). As a consequence, all Replicas leased by Node A from Node B and that are part of the same LeaseGroup will always have the same Lease expiration time.

In an alternative embodiment of the invention, X-PRISO manages Object Leases on a per-Object basis, rather than on the basis of LeaseGroups. This alternate embodiment is easier to implement, but has larger memory and communication bandwidth requirements.

Generally, Objects are not being replicated one by one, but in groups of related Replicas. This behavior was described above. However, each Object in such a group is replicated according to the protocol described in this section, even if multiple replications are mapped onto the same Message or Messages. Similarly, the Objects replicated as a result of the same request may or may not belong to the same LeaseGroup.

Expiration of a Lease

If a Node B has leased one or more Replicas from Node A, and their Leases are not successfully renewed in time, all Replicas subject to the expired Leases expire at Node B and become Zombies at the time their respective Lease ends. Zombies do not receive, nor do they send updates from and to Nodes that hold other Replicas of the same Object, as live (i.e. non-Zombie) Replicas are required to when they change.

As there may be multiple LeaseGroups with different expiration dates in force between any Node A and Node B at any time, some Object Replicas obtained by a Node A from a Node B may become Zombies as some point in time, while other Object Replicas also obtained by Node A from Node B may still have valid Leases.

Zombies, and Zombie Revival

As soon as one or more Replicas become Zombies at a Node A, Node A typically discards them as part of a garbage collection operation. However, the Node may attempt to renew its Zombies with a special interaction (see below). This revival protocol mostly exists in order to support the situation where a Node or connection between Nodes was off-line (down, or disconnected) for some period of time that prevented it from renewing its Leases in time.

Note that the expiration of a Lease does not require any exchange of Messages. Both Nodes participating in a Lease measure time since the Lease was granted and compare that to the duration of the Lease. If the Lease is not renewed in time, both Nodes realize, independently from each other, that the Lease has expired and take suitable cleanup actions on their own.

As many changes may have happened since the expiration of the Lease that were not forwarded, any attempt to revive a Zombie has a high likelihood of failure. In order to attempt to revive a Zombie, Node B sends a request to revive the Lease for an Object X (identified by its unique identifier) to Node A. It also specifies for how long it would like to obtain a new, revived Lease. If Node A is able to, and wants to help Node B revive the Zombie, Node A will send a Message to Node B that contains a serialized form of Object X with all of its Properties. It also assigns Object X to an (existing or new) LeaseGroup that specifies the duration of the Lease. If Node B does not revive the Zombie, the next Message from Node B to Node A, confirming the request Message, will not mention Object X, indicating that the revival request was denied.

Lease Duration Negotiation

If Node B attempts to obtain or revive a Lease for Object X from Node A, Node A and Node B need to agree on the duration of the Lease. Instead of predefining a default lease duration, the present invention recognizes that different application domains and situations may want to use different Lease durations. Instead, the present invention provides a simple negotiation algorithm for two Nodes to agree on a suitable duration.

When Node B attempts to obtain, renew or revive a Lease from Node A, it sends, as part of the Message, the duration it would like the Lease to last from the time it has been granted or renewed. Unless good reasons (see below) speak against it, Node A will grant the Lease for that period of time. It indicates the actually granted duration of the Lease (in milliseconds) in the response message by placing Object X in a LeaseGroup that carries the current duration of the Lease. However, Node A is under no obligation to grant the Lease, or grant a Lease for the specific duration requested.

Node A has good reasons to respond negatively, or with an actual duration for the Lease that is different from the requested duration if one of the following occurs:
Node A does not actually have a Replica of the requested Object, and cannot grant the Lease. (A Node is free to attempt to obtain a Replica from another Node first for itself, before responding to Node B, to which it then could grant a Lease, but it is not required to do so). In this case, the request is flatly denied.
Node A does have a Replica of the requested Object, but that Replica is subject to a Lease itself from a 3^{rd} Node, and this Lease expires earlier than the requested Lease duration. In this case, Node A may grant a shorter Lease duration than requested, or not grant a Lease at all. (Node A is free to attempt to extend its own Lease first, before responding to Node B, in order to be able to grant the requested duration of the Lease, but is not required to do so.)

Depending on the underlying transport for X-PRISO, there may be a substantial time lag between the time a sending Node sends a Message and the Message is received by the receiving Node. X-PRISO does not make any assumptions about how long Message transport takes, nor does it, by itself, have or require any capabilities to determine the characteristics of the transport. (Nodes certainly may take collected or projected performance information into account when deciding on which Lease durations to request or grant if they choose to.)

Care must be taken in implementations to calculate expiration and other time points pessimistically with such transport delays in mind. For example, a Node A requesting a Lease from Node B for duration d should only start measuring time with respect to its own obligations once it has received the Lease-granting Message back from Node B, not at the time it requested the Lease originally. However, with respect to renewing the Lease, or with respect to trusting that Node B meets its obligations, it should count the actually granted lease duration from the time it requested it, not from the time it obtained it.

Of course, such a pessimistic implementation means that a Node may still receive Messages for a Replica of Object X for a time period after Object X's Lease has expired, or after it has been garbage collected. Implementations must tolerate such Messages although they may ignore them.

In an alternative embodiment, the present invention requires synchronized clocks at all Nodes in the Distributed Systems and all times are expressed in absolute units rather than in relative units. In this alternative embodiment, some of the time lag effects are reduced. This embodiment requires synchronized clocks across the Distributed System, however, which may or may not be available.

Lease Renewal

Any Message from a sending Node A to a receiving Node B may carry either (depending in which Node requested and which Node granted the Lease) of the following two elements at most once for each LeaseGroup:
The duration for which Node A would like to renew the Leases collected in this LeaseGroup
The duration for which Node A grants a Lease extension to the Objects in this LeaseGroup.

Consequently, every Message exchange between two Nodes can extend the durations of the Leases between the Replicas between the two Nodes without having to list the Objects subject to the Lease individually. In the preferred embodiment, this behavior was chosen for efficiency reasons.

Canceling a Lease

Over some time period of operation, Node A may request Leases for more and more objects X1, X2, . . . from Node B, creating more and more Replicas at Node A of Objects held by Node B. As discussed above, there is only one expiration time for all Replicas at a Node A collected by the same LeaseGroup and obtained from the same Node B. This means that all Objects in the LeaseGroup will continue to be renewed, even if not all of them are still needed at Node A. This may cause unnecessary communications overhead as all Objects subject to an active Lease must forward change events, which, in this case, are not needed by Node A any more.

Node A may become aware that it does not need the Leases for some of the previously leased Replicas (e.g. the Xn with n small) any more. A special protocol exists for canceling a Lease for a Replica that is not longer needed, in spite of continuing the Leases of other Replicas from the same Node that may be part of the same LeaseGroup.

To cancel a Lease for a Replica for Object X, Node A sends a cancellation request to Node B containing Object X's identifier. Node B will stop notifying Node A of changes affecting Object X, Node A will discard its Replica of Object X, and Node B will remove Object X from its internal list of members of the LeaseGroup. There is no acknowledgement sent back from Node B to Node A, other than regular Message confirmation (see above).

To cancel an entire LeaseGroup, Node A sends a cancellation request to Node B with the identifier of the LeaseGroup.

Splitting a LeaseGroup

For various reasons, (such as diverging interaction patterns by the collaboration participant for different Objects over some period of time), it may be desirable for a Node A that is the receiver of a LeaseGroup granted by a Node B to request Node B to split the LeaseGroup into two or more LeaseGroups that are then managed independently from each other. To accomplish this, Node A sends a LeaseGroup split request to Node B, identifying the to-be-split LeaseGroup by its identifier. Further, for each additional LeaseGroup to be created, it lists the identifiers of those Objects that shall cease to be subject to the original LeaseGroup and shall become managed by the new LeaseGroup, and the requested duration of each new LeaseGroup.

If a granting Node B responds to a LeaseGroup split request from a Node A, or if a Node B has granted a LeaseGroup to a Node A and wishes to split the LeaseGroup into two or more LeaseGroups without having been requested to do so, the following approach is used: Node B sends a Message to Node A, listing all newly created LeaseGroups with their expiration time, and comprising the identifiers of the Replicas that have become subject to the new LeaseGroup; this is in complete analogy to the information sent when initially responding to a new LeaseGroup request. Upon receipt of the Message by Node A, Node A will remove the Replicas that are now subject to the new LeaseGroups from its internal representation of the original LeaseGroup, and assign it to the newly created LeaseGroups.

Moving a Lock

Among all Replicas of Object X, exactly one of these Replicas, has the Lock. We may call this Node B. This means that Node B has the right to update its Replica of Object X, and that Node B has the obligation to notify (directly or indirectly) all other Replicas of any changes that affect Object X, so that all Replicas of Object X throughout the Distributed System can be kept consistent. A Replica that does not have the Lock may not be updated, unless the Node first successfully acquires the Lock from the Node with the Replica that currently has the Lock.

If Node A would like obtain the Lock of Object X from Node B, it sends a Message containing the Lock request for Object X. Object X is identified by its unique identifier in the Message. Node B has the choice of relinquishing the Lock to Node A or keeping it. Further, Node B may not actually own the Lock at this point in time, so it may not be able to relinquish it. If Node B is able to and does relinquish the Lock, it responds with a Message listing Object X (by specifying Object X's unique identifier) as having relinquished the lock. Generally, if a Node B receives a request to relinquish a Lock to a Node A but does not actually have the Lock, and has no good reasons not wanting to help, Node B should attempt to acquire the Lock from another Node C and once it has received it, forward it to Node by responding positively to its original request.

A Node B can also take the initiative of pushing the Lock for one of its Replicas of an Object X for which Node B holds the Lock to another Node A that it participates in a Lease with for Object X. For example, it may want to do this prior to a planned period of unavailability, in order to enable other Nodes to continue updating Object X during the period of unavailability of the Node that holds the Lock.

From an implementation perspective, if a Replica without the Lock participates in more than one Lease, the Replica needs to keep track from which (other) Replica to request the Lock in cases it wanted to acquire it at some time in the future. If it did not keep track, it would have to send speculative Lock request messages to several Nodes, which in turn might need to consult other Nodes, creating a tremendous amount of network traffic, most of which would be futile. Therefore, a Replica should note the Node towards which the Lock moved last time the Lock moved through or left from the current Replica. (This is possible as one can think of the set of all Replicas of an Object X as the nodes, and the remembered direction towards the Lock as the edges of a directed, acyclic graph. This graph has the same topology as the Replica Graph, but its edges are typically directed differently as the point towards the Lock, rather than the Home Replica. By following the directed edges of this graph, the Replica holding the Lock can be found.)

If a Node B has granted a Lease for Object X to Node A, and if at the time of expiration of the Lease, the Lock for the Object X Replicas is still found in the direction of Node A, Node B unilaterally must reclaim the Lock. Similarly, even if Node A intends to revive the Lease or has even attempted to renew it (but not in time, thereby causing its Replica to become a Zombie), Node A must drop the Lock to avoid having more than one Lock for the same Object X in the System.

Moving a Home Replica

Among an Object X's Replicas, the Home Replica is the only Replica not subject to a Lease. In a sense, the Home Replica constitutes the “master” Replica for Object X. However, being the Home Replica does not convey updating rights; that is managed through the Lock. The Replica holding the Lock may or may not be the Home Replica at any point in time.

When a new Object X is created, the created (initially single) Replica is automatically the Home Replica, and will remain the Home Replica until the Home Replica may be moved.

Moving the Home Replica is a “push” operation, not one based on requests as virtually all other operations. A Home Replica for Object X can only be moved from Node A to Node B if both Node A and Node B have Replicas of Object X and if they participate in a currently active Lease. In order to move the Home Replica from a Node A to a Node B, Node A sends a Message to Node B “pushing” the Home Replica by identifying Object X's unique identifier. If for whatever reason, Node B does not want to own the Home Replica, Node B can continue pushing the Home Replica to another Node C (subject to the same conditions of participating in a currently active Lease with it), or push it right back to Node A. Such a “push” may be initiated by Node B requesting that Node A push the Home Replica of Object X.

In an alternate embodiment, a Home Replica request operation exists by which a Node B may request from a Node A that the Home Replica of an Object X to be moved from Node A to Node B.

A Message indicating the move of the Home Replica for an Object X must also contain the equivalent of a Lease renewal interaction, as the Replica that previously was the Home Replica now becomes a leased Replica from the new Home Replica. (This does not create a “hole” in the time line of Leases as the transfer of the Home Replica is only confirmed once the Node holding the old Home Replica has received a Message—any Message—confirming the receipt of the Message containing the Home Replica push. The same Messages contain the new Lease request and the Lease approval/denial.)

All Nodes share the responsibility to avoid creating infinite loops pushing the Home Replica around. Typically, this is not a problem as moving the Home Replica tends to be a fairly infrequent operation in most circumstances.

Moving the Home Replica is an operation typically only used by Nodes that are resource constrained, or that have low availability. For example, if a user creates a new Object X on a mobile device (Node A) with restricted memory, it may be advantageous for Node A to push the Home Replica to a Node B, if Node B is permanently on the network with sufficient storage and communication capacity. Node A is under no obligation to move the Lock at the same time. However, as the then-current Home Replica constitutes the root of all granted Leases, Node A might potentially lose its Lock if its simultaneously-created Lease expires before it can be renewed.

To avoid pushing the Home Replica to a Node that is unsuitable for long-term persistence (e.g. a mobile device), additional protocols can be devised that can characterize Nodes by their capabilities (e.g. for long-term storage) and provide that information upon request. Those skilled in the art will readily recognize such protocols as straightforward extensions of the present invention.

Forwarding a Property Change

If a Property is changed on a Replica of Object X on Node A, this change needs to be forwarded to all other Replicas of Object X at all other Nodes. A Property change of Object X may only originate from a Replica that has the Lock at the time of the change.

To forward such a Property change, Node A sends a Message to each of the Nodes B that have Replicas of Object X and which participate in a Lease with Node A's Replica: each non-leaf Node in the Replication Graph is then responsible for forwarding the Message to those Nodes C that carry Replicas of Object X and with which Node B participates in a Lease for Object X. This process continues recursively. Through this mechanism, Property change events are forwarded to all Nodes carrying a Non-Zombie Replica of Object X

The Message carries, at a minimum, the following information:
The unique identifier of Object X, indicating that a Property of Object X changed.
The unique identifier of PropertyType Y, if Object X's Y Property changed.
The new value of Object X's Property Y.

In an alternate embodiment, instead of carrying the new value of Object X's Property Y, the Message may either carry the new value of Object X's Property Y, or carry instead a description of an algorithm to determine the new value for Object X's Property Y. For example, such a description of an algorithm may indicate for a Property that represents a (long) text document: “take the current value and replace all uppercase characters in the second paragraph on the third page with lowercase”.

While generally, X-PRISO does not require Nodes to send Messages promptly, Nodes are encouraged to do so. Regardless of timeliness, Nodes must make sure that the causality and relative ordering of Messages remains correct: for example, all Property changes of Object X must not be received and processed by Node B from Node A after Node B acquires the Lock from Node A for Object X.

Deleting Objects

If the collaboration participant directly interacting with Node A performs a semantic delete operation on a Replica of Object X on Node A, all other Replicas of Object X at all other Nodes must be deleted as well. A semantic delete operation on Object X may only originate from a Node A that has the Lock for Object X at the time of the delete operation. Further, in case of Entities, a semantic delete operation on Entity X may only originate from a Node A that has the Lock for Entity X, and that also has the Lock for all Relationships Yi whose source or destination is Entity X; the Message containing the deletion of Entity X also must contain the deletion of Relationships Yi, in order to avoid dangling Relationships, which are prohibited in the preferred embodiment.

Note that a semantic delete is different from simply deleting a Replica: a semantic delete implies that Object X and what it stands for in its application domain is being deleted, regardless of the number of Replicas of it may exist across the Distributed System, while simply deleting a Replica that is not the Home Replica has no further consequences to all other Nodes; depending on a Node's capabilities, the Replica could be restored transparently (to the user) by replicating Object X again from a suitable Node that still has a Replica. Deleting the Home Replica is not allowed, unless the Home Replica has the Lock at the time of the delete operation, in which case the delete operation must be a semantic delete operation.

To forward the semantic delete to all other Nodes, Node A sends a Message (containing Object X's identifier to identify which Object was deleted) to each of the Nodes that have Replicas of Object X and which are in a Lease with Node A's Replica: each Node in the Replication Graph is responsible for forwarding the Message to the other Nodes it knows have Replicas of Object X, in analogy to how Property change events are forwarded to the Nodes holding Replicas of Object X in the Distributed System.

Transmogrification

Some object type systems provide the ability of objects to change their type at run-time while keeping their identity and all unaffected associated information without change. In the X-PRISO context, this ability is called transmogrification.

In the preferred embodiment, transmogrification of an Entity X from EntityType T to EntityType U may only take place if the Relationships in which Entity X is the source or destination permit a source Entity or destination Entity of type U. (This also implies that a transmogrification operation may only be performed on Entities that are “complete”, as otherwise this check cannot be performed.). Further, in the preferred embodiment, transmogrification of a Relationship X from RelationshipType T to RelationshipType U may only take place if the Entities that are the source and destination of Relationship X are permitted as a source and destination, respectively, for a Relationship of type U.

If the collaboration participant directly interacting with Node A transmogrifies a Replica of Object X on Node A from type T to type U, this transmogrification change is forwarded to all other Replicas of Object X at all other Nodes that have such Replicas, in analogy to how Property change events are forwarded. A transmogrification change of Object X may only originate from a Replica that has the Lock at the time of the change.

To forward such an transmogrification change, Node A sends a Message to each of the Nodes that have Replicas of Object X and which are in a Lease with Node A's Replica: each Node in the Replication Graph is responsible for forwarding the Message to the other Nodes it knows have Replicas of Object X.

The Message carries the following information:
The unique identifier of Object X, indicating that Object X was transmogrified.

The unique identifier of the new EntityType (for Entities) or RelationshipType (for Relationships) U, identifying the new object type that Object X was transmogrified to. The set of all Properties of Object X, with their values as they are after the transmogrification. In alternate embodiment, the Message only contains the values of those Properties of Object X that have changed, or it contains descriptions of algorithms for how to determine the values of those Properties in analogy to the information conveyed for Property change events, as discussed above. In the preferred embodiment, an Entity may only be transmogrified into another Entity, a Relationship only into another Relationship. Further, the transmogrification of a Relationship may not change its source or destination.

In an alternate embodiment, the requirements of source and destination constancy are not present, and the Message indicating the transmogrification also carried the unique identifiers of the new source and destination Entities of the (post-transmogrification) Relationship. In this alternate embodiment, an Entity may also be transmogrified into a Relationships, and vice versa.

Object Creation

When a new Object X is created at Node A, generally, no further action is necessary (but see section on Relationship creation below). This is due to the design principle in the preferred embodiment that, unless otherwise required, Replicas are only created on an additional Node when that additional Node specifically needs to obtain a Replica of the new Object X.

In an alternate embodiment, the creation of any new Object X at a Node A is always forwarded to a Node B by automatically granting Node B a Lease to Object X without Node B having requested such as Lease.

Additional Behavior for Relationship Creation

When a new Relationship R is created between a Replica of Object X at Node A, and a Replica of Object Y at Node A, other Nodes that have Replicas of either Object X or Object Y (or both) may need to be notified about the existence of this new Relationship R. Specifically, they need to be notified if the Replica of Object X or the Replica of Object Y at one of those Nodes is “complete”.

To notify, Node A sends Relationship R in serialized form to the set of Nodes that participate in an active Lease with Node A with respect to either Object X or Object Y (or both). This is the same as the protocol and criteria for forwarding used for first-time replication, the criteria for what other Objects to exchange based on “completeness” and “incompleteness” apply, and the protocol for conveying that a previously “incomplete” Object is now “complete” and the information associated with it.

Resynchronization of Replicas

If the Distributed System worked flawlessly at all times and connectivity was always available when needed, this scenario would not be required. However, in real-world Distributed Systems, flawless operation cannot be assumed: data transmission errors, bugs in participating software and catastrophic failures with data loss at one or more Nodes may cause the system to accumulate errors or inconsistencies of various kinds.

To address this challenge, the present invention allows any Node A to send a Message to Node B requesting that it wants to re-validate one or more Objects Xi for which it believes (correctly or incorrectly) that it has obtained a Replica from Node B. Node B is obliged to respond with the serialized Objects for which that is true, which Node A is then able to validate against its own copy and take appropriate reconciliation action if necessary. In the preferred embodiment, Node A will change the Properties of its Replicas Xi to the obtained values, and forward the changes in analogy to the behavior in case of regular property changes.

In case Node B does not know anything about a specified Object X, it will not respond with a serialized representation of Object X in its response Message confirming the receipt of the request Message, indicating to Node A that a serious inconsistency occurred. It is up to the implementation of Node A to decide how to proceed. In the preferred embodiment, Node A will delete its Replica of X as if Node B had forwarded a delete change for Object X, and forward the delete change in analogy to the behavior in case of a delete change.

Determining the Replica Graph

If a Node C has obtained a Replica for Objects X from a Node B, Node C may query Node B for the complete set of Nodes that Node B is aware of that have Replicas of Object X.

Node B responds with a set of Nodes, specially marking that Node in the set towards which the Home Replica of Object X may be found.

Although Node B is encouraged to provide Replica Graph information to a querying Node C, Node B is not obliged to share this information. Node B may also choose to reply only with a subset of the Nodes that it is aware of having a Replica of Object X, for reasons such as security.

Modifying the Replica Graph

A Node C may have obtained a Replica of Object X from Node B, which in turn has obtained it (directly or indirectly) from Node A. It may be desirable for Node C to modify the Replica Graph, such as by attempting to obtain a Lease for the Replica of Object X directly from Node A, foregoing its Lease from Node B. (Note that such a modification of the Replica Graph does not have any semantic consequences.)

As discussed, Node C may query Node B for the set of Nodes that Node B knows that have Replicas of an Object X. If the received response set contains a Node A, Node C can now directly approach Node A and request a Lease for Object X. If Node A grants the request, Node C has entered into a Lease with Node A regarding Object X. In order to avoid having more than one current Lease for the same Object X from different Nodes, Node C will then cancel its Lease of Object X from Node B. (Note that during the time period from Node A having successfully obtained a Lease from Node C, and Node B having received the cancel Message from Node A, both Nodes B and C will forward change-related Messages to Node A. Node A must handle those correctly.)

Node A, like for any replication request, is not required to grant a Lease for Object X to Node C, in which case Node C would have to stick with a Lease for Object X from Node B.

Using these capabilities, Distributed Systems can implement behaviors that optimize Replica Graphs according to criteria they choose. For example, a Distributed System may attempt to modify all Replica Graphs in a manner that makes the longest directed path within the Replica Graph have length 1 (i.e. all Replicas of any Object X participate in Leases directly with the Node holding the Home Replica.).

Alternatively, a Distributed System may attempt to turn the Replica Graph into a balanced tree with N branches per node in the Replica Graph (“optimal load distribution”). Many other strategies are possible, and can be chosen by Node implementers to support their particular requirements.

Note that in the general case (in which the Distributed System is heterogeneous), a Node A does not know the specific Replica Graph modification strategies that other Nodes may be using, as those other Nodes may have been implemented using different algorithms and by different implementors. Only conformance to X-PRISO can be presumed. Consequently, implementations must be robust with respect to different Replica Graph modification strategies (and all other behaviors allowed by X-PRISO, of course). Specifically, implementations should take note of possible livelocks—where several Nodes “flip” back and forth between two or more states without ever stabilizing.

Finding Nodes

X-PRISO does not attempt to provide a general-purpose Node discovery protocol. For that purpose, a number of protocols exist already in the marketplace, ranging from fully centralized to fully decentralized directories and search algorithms. In principle, any of them can be used in connection with X-PRISO.

X-PRISO does provide two indirect mechanisms for Node discovery, however:

The first one was discussed previously: if a Node C has obtained a Lease from a Node B for an Object X, it can query Node B for the set of Nodes that Node B knows have other Replicas of Object X, such as Node A. Through this mechanism, Node C can learn about the existence of Node A.

Secondly, a Node C often obtains Leases for Objects from Node B for which Node B does not possess the Home Replica, but some Node A does. By obtaining the Lease from Node B, Node C indirectly accesses Node A—although it may not be aware of it. Through the previously described mechanism, Node C can then obtain explicit knowledge of Node A.

Access Control and X-PRISO

For some application scenarios, it may be appropriate to define access control policies for Objects. For example, in the example in FIG. 7, some Nodes in the Distributed System (and by implication, the users at those Nodes) may only be allowed to access Orders whose Amount is greater than $30 according to some access control policy. The access control policies may be defined in various manners, including through Objects that are instances of a security information model. Regardless of the definition, however, their enforcement has implications for the Distributed System:

If a Node B with restricted access rights (for example: may access all Customers, but only Orders above $30) requests a Replica of Object O-1-3 (705) from Node A (that has access to all Replicas), Node A will only provide those Objects to Node B that Node A has access rights to. Node A can identify Node B by any means of its choosing, including trusting the sender Node Identifier in the Message, public-key cryptography or any other means.

Consequently, in this case, the previously shown table describing which information is exchanged is modified as follows:

| | | Complete/ |
|---|---|---|
| Scope | Replicated Objects | incomplete Entity |
| 0 | O-1-3 (third Order) | incomplete |
| 1 and higher | O-1-3 (third Order) | complete |
| | P-1-3 (third Places Relationship) | n/a |
| | C-1 (first Customer) | complete |

Note that as a result of Node B not having access rights to all Objects known at Node A, Node B believes at the end of this exchange that it has all Relationships associated with Customer C-1 (701), as evidenced by the “complete” mark in the C-1 row in the table. For security reasons, this is a desirable outcome in most application scenarios, as it not only protects the information that Node B is not allowed to access, but also hides the existence of such information from Node B.

If, subsequently, a Node C requests Replicas from Node B, it necessarily can only obtain Node B's view on the information, which is limited by its limited access rights. If Node C has less restricted access rights that Node B (e.g. it may access all Objects held by Node A), this means that Node C obtains incomplete information by querying Node B. However, using the approach for querying and modifying the Replica Graph described above, Node C can find out about Node A and request the full view directly from Node A without being restricted by the limited access rights of Node B.

Depending on the application requirements, the following alternate embodiment of the invention may be advantageous: In the previously described scenario, Node A does not give Node B any indication that additional Orders may exist beyond the single one that Node B has access rights to, leaving Node B in the belief that the Customer has only placed one Order. This is a suitable response for many application domains, but may be unsuitable in others, where it would be more suitable for Node B to obtain “stubs” for all Order Objects, even if it could not access the information they carry (i.e. the specific subtype of Order, if any, and some of the Properties carried by the Order).

If this second scenario is desired, in the alternate embodiment Node A responds as if Node B had access rights to all information held by A, but instead of conveying that Objects O-1-1 (703) and O-1-2 (704) are of type Order, and carry certain Properties with certain values, it would convey that Objects O-1-1 (703) and O-1-2 (704) are instances of an EntityType S (that does not carry those Properties). For this to work, EntityType S must be a supertype of Order, and also participate in the Places Relationship (i.e. the information model shown in FIG. 6 would have to be modified to introduce supertype S). If a Node B is being told by a Node A that an Object X has a type S, but in reality Object X has a type T (which is a subtype of S), the replica of Object X at Node B is said to be of an incomplete type.

In this alternate embodiment, Node C would also obtain incomplete information from Node B if it initially contacted Node B. But similarly to the first scenario, it could then query Node B for its view on the Replica Graph, and then contact Node A to obtain Replicas directly. Node A would respond with the correct subtypes (i.e. Orders rather than Ss), and Node C would perform a transmogrification (here: downcast) operation on Object X to hold the most specific subtype it can determine.

Combinations of both scenarios are possible depending on the application requirements.

In yet another alternate embodiment, the rule that all Properties must be shared across all Replicas is relaxed, and a new value “private” is introduced into all value domains of all supported data types. This allows the Replicas of all Order Objects (703, 704, 705) to be instantiated at Node B, but the set of protected Properties would carry the special value “private” because that is what Node A indicated they were when Node B requested them.

Changing access rights during operation of the Distributed System, by Nodes, or for specific Objects, can be supported similarly. In this, if a Node A realizes that Node B may now access more information than it had been allowed to previously, Node A will send the same type of Message to Node B as it would have sent if Node B had requested a resynchronization of Object X (see above).

Sending Responses Without Prior Requests

Nodes are discouraged from, but allowed to send content in Messages that is described in this document as the response to a particular request, but without having received such a request. For example, a Node A may grant a Lease for an Object X to a Node B, without Node B having first requested such a Lease from Node A. Nodes must be tolerant of such incoming Messages and behave appropriately.

X-PRISO Node Implementation

Now, an overview and guidance is given on how to implement, in a software embodiment of the invention, Nodes supporting the X-PRISO protocol. While the present invention can be implemented in many different ways and not just in software, the preferred embodiment uses software, and this section describes the preferred embodiment.

When considering this question in detail, there are obviously many different implementation alternatives that can be used, employing different operating systems, programming languages, toolkits, methods of information storage, transports for information exchange and so forth.

However, implementation alternatives tend to share certain commonalities that are an implication of the basic features of the present invention which are focused on herein. For applications that use only a subset of the X-PRISO functionality, or for applications that can make additional assumptions, Node implementations may not require all of the concepts and algorithms presented here.

FIG. 9 shows an architectural overview of an exemplary Node 901, implemented in software, that is part of a Distributed System in accordance with the invention. Generally, the Node 901 may, at any time, communicate with one or more other Nodes, using the same or different communication protocols for each. A wide range of communication protocols can be used, ranging from Bluetooth, Ethernet, infrared, serial and other wired and wireless protocols, over Internet Protocol packets, SMTP and NNTP to sockets, RPC, Java/RMI, COM/DCOM, CORBA, HTTP, FTP as well as SOAP, XML-RPC, XMPP and other instant messaging protocols and many other protocols that can be used to send messages. Any such protocol may or may not apply encryption and other security features as provided by security systems such as SSL, SSH, TLS and many others.

As outlined earlier, even non-electronic communication protocols can be used. Given that X-PRISO supports multi-protocol communications (see above), a Node may simultaneously use several communication protocols for communicating with the same other Node. Thus, as shown in the diagram, Node A 901 communicates with Nodes B, C and D, using communication protocols “1” (908a), “2” (908b) etc. As will be readily apparent to those skilled in the art, the number and types of proxies 904 and protocol handler managers 902 may vary without deviating from the principles and spirit of the present invention. The Node 901 further comprises one or more elements/modules, each of which may be implemented in software having a plurality of lines of computer code that are executed by a processor of the computing resource on which the Node is being executed to implement the operations and functions of the Node. In accordance with the invention, each Node may be implemented using a computing resource, such as a PC, workstation, mobile device, etc., with at least a general-purpose or special-purpose processor, memory and, optionally, a persistent storage device so that each computing resource is capable of executing software module(s) to implement the functions of the node as described in more detail below. Thus, in the example shown in FIG. 9, the Node 901 further comprises one or more protocol managers 902, one or more proxies 904 (904b-d in the example shown in FIG. 9), a transaction serializer 906, an information storage unit 907 and a lease manager 909.

Protocol Managers

For each communication protocol and each Node with which Node A communicates, Node A uses a protocol manager 902, such as protocol manager 1 and 2 for communications over two different transport protocols 908a, 908b with Node B and the like. The protocol manager converts communication protocol-independent X-PRISO Messages to and from the particular conventions and Message encodings of the particular communication protocol.

For protocols that require it, the protocol manager is responsible to register itself (on behalf of its Node and its proxy) with the appropriate, protocol-specific naming service, so Messages sent by other Nodes to this Node using this communication protocol can be routed correctly. For example, an instant messaging protocol manager would log on to the instant message system upon startup and register its IM handle as being present. An HTTP POST protocol manager that runs its own web server, on the other hand, would not do so, assuming that the hostname part of the URLs it handles is appropriately registered in the Internet domain name system.

Incoming Messages from one of the other Nodes first reach the protocol manager 902 specific to the communication protocol that is being employed for this Message. For example, an Message coming in through a plain socket would be handled by a protocol manager listening to the appropriate port; a Message coming in through an instant messaging connection would be handled by a communications manager that can obtain, evaluate and pass on “incoming (instant) message” events. The respective protocol manager typically decodes incoming Messages synchronously. It then stores the decoded Message in a protocol-independent way in the “in” queue 903b, 903c, 903d of the corresponding proxy 904b, 904c and 904d, respectively.

The proxy for the Node then performs appropriate operations on the Object Graph and other information held by Node A. Node A holds all information in the information storage 907, guarded by the transaction serializer 906 in order to prevent non-atomic operations on information storage 907.

The proxy 904b, 904c, 904d sends outgoing generic X-PRISO Messages to the respective protocol manager 902. The protocol manager encodes the Message suitably for the respective protocol, and deposits the encoded Message in an outgoing message queue 905 for this protocol manager. Note that there are N outgoing queues for N protocols by the same proxy, but only one incoming queue. This reflects the fact that outgoing protocols may have very different characteristics with respect to availability, buffer characteristics of the protocol (e.g. an instant messaging-based protocol will often buffer the message, while a direct socket connection will not) and others, while on the incoming side, it is most useful for the proxy to obtain incoming Messages from one queue for processing.

As can be readily recognized by those skilled in the art, other implementation architectures are possible without deviating from the spirit and principles of the invention.

Proxies

Proxies 904a, 904b, 904c manage all information in a Node A that directly relates to another Node N, such as Node B, C and D in FIG. 9. Thus, Node A has exactly one proxy for each Node with which Node A communicates. Specifically, a proxy manages the following information:
The set of LeaseGroups LG(A,N) that Node A has granted to Node N, their respective expiration times, and the set of Objects belonging to each LeaseGroup.
The set of LeaseGroups LO(A,N) that Node A has obtained from Node N, their respective expiration times, and the set of Objects belonging to each LeaseGroup.
For each Object X that is contained in either LG(A,N) or LO(A,N), whether or not the Lock is currently held in the direction of Node N, or not. (This information could alternatively be held in the information storage as a “pointer” associated with its representation of Object X to the proxy in whose direction the Lock can be found, or using other ways of representing the same information, as would be readily apparent to those skilled in the art). Holding this information is necessary for Node A to be able to request the Lock from the correct Node when it needs to. As the Node does not have a global view of the Replica Graph, it typically can only store whether or not the Lock is held in the direction of Node N, but it cannot identify whether the Lock is held by Node N itself or by another Node “behind” Node N.
The set of Messages sent from Node A to Node N that have not been confirmed yet by Node N.
The set of Messages received from Node N by Node A that have not been confirmed yet by Node A.
A copy of the first Message sent by Node A to Node N (i.e. the Message with Message Identifier 1).
A copy of the first Message sent by Node N to Node A and received by Node 1 (i.e. the Message with Message Identifier 1).

A proxy processes its incoming Messages by sequentially reading Messages from its incoming message queue, the sequence of read Messages being constituted not by the time of Message arrival, but by Message Identifier. It decides on whether to grant or deny the requests by Node N, updates the relevant information at Node A, and constructs appropriate response Messages to Node N. It may also contact other proxies and request certain actions from them and determine responses prior to responding to Node N (e.g. moving the Lock across multiple Nodes).

Further, any proxy 904b, 904c, 904d monitors changes to the information held by the information storage 907. These changes may be caused by other proxies, by the user through a locally running application, or through some sort of software agent. When relevant changes occur (e.g. a Property of a leased Object changed its value), the proxy updates itself and assembles an appropriate Message to Node N, which is then sent, or queued to be sent, as described before.

The proxy also manages Message confirmation and resending as described above in the context of Message handshaking. Most importantly, it will pay attention to the Message Identifier of incoming Messages from Node N, and instruct Node N to resend certain Messages that were lost.

Incoming Message Queues 903b, 903c and 904d

The incoming message queue is managed by its proxy. Any thread-synchronized queue can be used; however, better performance can be achieved if a priority queue is used whose priority criterion is the Message Identifier. This is particularly advantageous when multiple protocols are used.

Smart Outgoing Message Queues 905

Two optimizations can be performed related to the outgoing messages queues.

Firstly, all outgoing message queues for the same proxy will typically be processing the same outgoing Message (smarter implementations may choose a subset only, but the overall optimization approach considered here still applies). If a protocol handler has a way of knowing that it just successfully sent an outgoing Message to Node N, it may instruct the other outgoing message queues of the same proxy to remove this Message, as it is known to have arrived successfully already. As some common communication protocols provide reliable message transfer as a standard feature, this optimization can be applied in many different circumstances.

Secondly, outgoing Messages with sequential Message Identifiers may sometimes be merged into one. For example, if Node A changes the value of the same Property several times in a short period of time, but if Node N, to which the changes need to be forwarded, cannot immediately be reached, it is advantageous for the outgoing message queues to merge a number of these Messages syntactically and/or semantically (see above) prior to sending them, e.g. by sending only one “consolidated” Property change. This is similar to the “Nagle algorithm” (such as used in TCP/IP) and may also be applied as a criterion for when Messages should be attempted to be sent immediately, or attempted to be held for some time to give them an opportunity to be merged first.

Care needs to be taken that in spite of Message merging, Node 1 sends out Messages with sequential Message Identifiers under all circumstances.

Transaction Serializer 906

A transaction serializer is employed to make sure that changes to all information held by a Node are protected against current modification and thread conflicts. Transactions here can be simple; they only need to guarantee that no other, concurrent thread can modify the state of the information held by a Node during the time the transaction is active. Transactions are generally active while incoming Messages are processed, and while outgoing Messages are being assembled.

Information Storage 907

In principle, any type of information storage can be used as long as the information storage is able to store the required information. Specifically, relational, object-relational, and object-oriented databases may be used, with or without distribution and replication features of their own. Higher-level information storage mechanisms including document management systems, repositories and others can also be used. Information Storage can also be file system based, based on XML, based on a single file implementation, or use any other implementation.

While it would generally be advantageous, information storage 907 is not required to be persistent (i.e. persistent beyond a reboot cycle of the Node). Storage in volatile memory may be appropriate for certain applications. In particular, storage in volatile memory only may be advantageous for certain scenarios where persistent storage of information is undesirable, such as in order to protect against security breaches when a mobile device running a Node is stolen.

Information storage generally includes information related to the semantic content of the shared Objects, and information related to the replication mechanisms provided by X-PRISO. One or more information storage devices may be used to store these two types of information together or separately. Together, they form information storage 907. In particular, it is possible to use an existing information storage (such as the database of an existing business application) for some or all of the shared Objects, and an additional information storage for the information related to the replication mechanisms provided by X-PRISO. This approach is one of the approaches that allow making existing software applications become X-PRISO enabled without requiring a complex redesign.

In an alternate embodiment of the present invention, the implementation of some of the protocol managers 902 and proxies 904b, 904c and 904d, including their constituent parts, is generated from a high-level description of the required behavior using a graphical or textual language such as Statecharts, message sequence diagrams, Petri Nets or similar high-level representations.

Lease Manager 909

A lease manager 909 is employed to monitor and manage the granting, renewal and the expiration of granted and obtained Leases by the Node to and from other Nodes, and other activities triggered by such an event.

When a Lease the Node has obtained from another Node is about to expire, the Lease manger may instruct proxy 904b-d to attempt to renew the Lease from the granting Node. Upon receiving the confirmation of a successful Lease renewal request, the Lease manager updates the information held by information storage 907 appropriately, via transaction serializer 906.

When the lease manager determines that the continuation of a Lease from another Node is not required any longer, the lease manager 909 will instruct proxy 904b-d to notify the other Node accordingly. Then, the lease manager will expire and delete the information about the lease held in information storage 907 accordingly, potentially deleting unnecessary Replicas.

Lease manager 909 may also be notified by proxy 904b-d that another Node has requested a new, or an extension to an existing Lease from this Node. Upon receipt of such a notification, lease manager 909 may grant the Lease or Lease extension, update the information stored in information storage 907 accordingly, via transaction serializer 906, and instruct proxy 904b-d to respond affirmatively to the requesting Node that the Lease was granted, carrying all the information that such a response requires (as discussed above).

Lease manager 909 is also responsible for initiating, or responding to requests for the Zombie revival protocol discussed above.

Testing

To test the conformance of a Node to the X-PRISO protocol, and to test the behavior of the Distributed System, the present invention employs the testing architecture shown in FIG. 10. Here, a human test operator 1001 interacts with a special test Node 1002. Test Node 1002 accesses any number of regular Nodes 1003 through a test protocol 1005, which includes the X-PRISO protocol as a subset. Regular Nodes 1003 may or may not communicate directly with each other through Messages 1004; they may also communicate with other Nodes not shown in the diagram.

Test Node 1002 contains mechanisms—well-known to those skilled in the art—that allow human test operator 1002:
to start, stop and suspend Nodes 1003
to send pre-constructed Messages to a pre-determined Node 1003 at pre-defined points in time, using the test protocol 1005
to receive Messages from Nodes 1003 through test protocol 1005
to compare received Messages with pre-constructed sample Messages, and to execute operator-defined test procedures on received Messages
to monitor and store the exchange of all Messages, or Messages that meet a certain criteria, between Nodes 1003
to replay stored Messages against a Node “as if” they had been received live
to enable and disable the transports of Messages between Nodes 1003
to measure the timing of received messages, both in absolute and in relative terms
to define response algorithms that are triggered upon receiving certain incoming Messages, and that create new Messages that then are sent to Nodes 1003 either immediately or at a future point in time. These algorithms may be developed manually by the test operator, or generated automatically.
to inspect the internal representation of X-PRISO related information in Nodes 1003
to make changes to the internal representation of X-PRISO related information in Nodes 1003
to view the state of the overall Distributed System
to define error conditions, and the mechanism by which test Node reports encountered error conditions
to view error conditions.

In an alternate embodiment, human test operator 1001 is replaced with an automated test operator that operates test Node 1002 according to a pre-defined test script and reports results.

Application Domains

As described in the introduction, X-PRISO and the individual techniques applied for X-PRISO and its implementations are applicable to a broad range of application domains that require distributed collaboration participants to share information, comprising the replication, integration, synchronization and relating of pieces of information, together constituting the shared information. Without limiting this broad range of application domains, here are some examples which can be implemented by those skilled in the art without requiring further description. In all cases where traditionally the unit of information is a file or stream, the present invention can be applied both on a document level (e.g. an entire HTML page is represented as a single Entity) and on an element level (e.g. one node of the document object model of an HTML page is represented as an Entity; the entire page is represented as a graph of related Entities and Relationships)
As a replacement for http, and similar protocols (e.g. ftp) that not only allows a client to obtain information from a server, but also 1) allows the client to make changes to the obtained information and pass it back to the server in a non-conflicting manner, and 2) enables the server to notify the client of changes to the information that the client previously obtained without the need for polling.
As a replacement for the web publishing/syndication formats RSS, Atom, evolutions of RSS, Atom and similar formats that not only allows a client to obtain a read-only copy of a snapshot of certain information held by the server, but also 1) allow the client to make changes to the obtained information and pass it back to the server in a non-conflicting manner, 2) enable the server to notify the client of changes to the information that the client previously obtained without the need for polling, and 3) offer the features described below as “annotation”. Unlike these web publishing/syndication formats, the present invention allows any type of information to be shared, not just today's (hard-coded) schema for news posts etc. defined for RSS and similar formats. It further allows the information in such web publishing/syndication formats to be shared in conjunction with other information whose information model may or may not be broadly agreed on (see discussion above on the exchange of the information model).
As a protocol that enables distributed information repositories to join forces and act as one, distributed, “virtually integrated” information repository. Such information repositories can be relational, object-based (including relational, object-relational, or object-oriented databases) or file-based or version/configuration management system based (including document management systems, repositories) and many others. The present invention enables this for the purposes of increasing availability, for the purposes of distributing load and reducing memory requirements on individual repositories, for cross-company/cross-organizational systems integration, and for many other purposes.
As a protocol that enables an information repository, or information server to be more highly available through replication.
As a smart caching mechanism for a variety of applications, from the caching of web pages to the caching of database content and others.
As an extension of NFS, WebDav and other protocols (e.g. Microsoft's remote file system protocols) that allow clients to “mount” remote file systems and other hierarchical structures (e.g. directories). X-PRISO enables the consistent “mounting” of actual, or virtual file systems even during network outages. It supports both simple file systems and those with advanced meta-data capabilities by leveraging its capabilities to share an arbitrarily-long list of Properties for any Entity, and to associate Relationships (whose RelationshipType is defined by the vendor, or the user, or both) with Entities.
As an underlying protocol for a decentralized file system in which several, or many computers cooperate, but in which none of the cooperating computers must necessarily hold a copy of all the data in the decentralized file system.
As a protocol to synchronize a user's, or a user group's contact, e-mail, notes, journal, personal information, and other information across the user's, or user group's set of personal and business devices and software. Specifically, as an extension of SyncML and its successors, substantially increasing the users' flexibility in information sharing and updating.
As a more efficient, and more functional replacement for core functionality of SMTP and NNTP and their derivations.
As a more functional replacement for proprietary or open collaboration, replication and synchronization protocols, including instant messaging and common extensions.
As a protocol that enables the construction of software system that support the “annotation” of information from another software system. “Annotation” is to be understood in a broad sense: this may be textual annotation, annotation with a variety of media types, but also the creation and management of relationships between the pieces of information in the information system, and information held in the same or a different location by another information system, developed jointly or independently.
As a mechanism for systems integration, by synchronizing (with distributed locking) pieces of information distributed across several information systems operated by the same, or different organizations.
As a mechanism for information sharing across computing platforms, operating systems, object frameworks and libraries, and/or programming languages.
As a mechanism for archiving, backup, restore and recovery.
As a mechanism to distribute, and keep up-to-date, the entries in a naming service such as the Internet's Domain Name Service (DNS) or (corporate) directories.
As a mechanism to support distributed authoring. Authored documents may contain one or more media types, and may also be hyper-documents (i.e. cross-linked documents through the use of hyperlinks or hyperlink-like relationships, in the same or in different locations) or may be software code.
As a mechanism to exchange, update and synchronize the exchange of partial documents between nodes in a distributed system (e.g. partial HTML or XML documents or other hierarchical or non-hierarchical documents).

In all cases, the access control mechanisms discussed above may be employed as well.

Message Format

This section provides an annotated example X-PRISO Message. This example uses XML syntax for that purpose. As those skilled in the art will recognize, Messages can be described, and can be transmitted using any other format that can capture the respective information content without deviating from the principles and spirit of the invention.

As an example, Objects may be serialized fully or partially using their native syntax (if any) in those places where X-PRISO foresees Objects serialization, or the serialization of individual values. For example, such a native XML syntax may be used if X-PRISO is applied to information expressed or expressable in XML. Object Identifiers can also be expressed differently, such as using XPath or other addressing schemes that allow the unique identification of information fragments within a sufficiently broad context.

Alternate syntaxes may also reverse the enclosing/enclosed roles of X-PRISO replication-related information and serialized Object information: while the XML-based syntax shown in this section uses X-PRISO replication-related information as the main part, and includes serialized Object information by bracketing it in special tags, the reverse is also possible: Serialized Objects in this or a native syntax for the described information may form the main part, and X-PRISO replication information may be included using a special inclusion syntax, such as through bracketing, quoting or escaping, or by simultaneously exchanging a second message. Those alternatives, and various hybrids, are generally possible for any message representation that contains both control and data parts, and are well-known to practitioners of the art, for example in the domain of programming languages (e.g. the syntax of the C programming language consists of program code in the main part, including text strings through quotations, while the TeX programming language consists of text, marking program code through the special backslash syntax). Through such a representation, X-PRISO information can be added to other types of information (e.g. HTML pages, XML content, and many others).

Further, any number of well-known methods for message compression and/or encryption may be used. In particular, a dictionary method may be used to reduce message length by replacing long identifiers with a short identifier, translatable through the dictionary, there being either one dictionary per message, or a dictionary that is maintained by two or more communicating nodes for use in more than one message. The mechanism of agreeing on suitable default values for certain expressions in a Message, if not otherwise given, is also well-known by those skilled in the art, and may be used for the present invention.

All absolute times in this XML syntax are given in UTC.

| | |
|---|---|
| <message | Indicates the beginning of a Message. This |
| id=“17” | Message is the 17^{th} message sent from this sender |
| created=“2003/04/05 12:34:56.789”> | to the same receiver. This Message was created |
| | by the sender on the 5^{th} of April, 2003, at 12:34 |
| | and 56.789 seconds, UTC. |
| <from> | Specifies the sender of the message. A sender can |
| | provide multiple addresses by which it can be |
| | reached. |
| <xmpp>foo@bar.com</xmpp> | One of the addresses by which the sender can be |
| | reached. This indicates the sender can be reached |
| | at this XMPP ID. |
| <email>foo@mail.bar.com</email> | One of the addresses by which the sender can be |
| | reached. This indicates the sender can be reached |
| | at this e-mail address. |
| </from> | |
| <to> | Specifies the receiver of the Message. Multiple |
| | addresses of the receiver can be specified. |
| <xmpp>bar@foo.com</xmpp> | This indicates the receiver can be reached at this |
| | XMPP ID. |
| </to> | |
| <confirm> | Lists the Identifiers of the Messages that the |
| | sender of this Message has received previously |
| | from the receiver and whose receipt the sender |
| | acknowledges. |
| <msg id=“4”/> | The sender acknowledges the Messages with |
| <msg id=“5”/> | number 4 and 5 that the receiver sent to the |
| | sender. |
| </confirm> | |
| <resend> | Lists the Identifiers of the Messages that the |
| | sender of this Message has a reason to believe |
| | were sent by the receiver, but which did not |
| | arrive. |
| <msg id=“6”/> | The sender believes the receiver has previously |
| <msg id=“7”/> | sent (at least) Messages with Message Identifiers |
| <msg id=“9”/> | 6, 7 and 9 but which did not arrive. The sender |
| | wants the receiver to resend those Messages. |
| | Given that there is a gap (Message Identifier 8 is |
| | not listed) in this particular example, it can be |
| | inferred that this sender previously received |
| | Messages with Message Identifier 8 and 10. |
| </resend> | |
| <permanent-quit/> | The sender indicates to the receiver that it is |
| | quitting permanently and does not want to receive |
| | any further Messages. |
| | This tag cannot be combined with the |
| | <unavailable/> |
| | tag, and is listed here just for explanatory reasons. |
| <unavailable | The sender indicates to the receiver that |
| millis=“123456”/> | immediately after sending this Message, it will be |
| | unavailable for an expected duration of 123.456 |
| | sec. This is an advisory tag, and can be ignored by |
| | the receiver (that might continue to attempt |
| | sending Messages which likely will be |
| | unsuccessful during this period). |
| | This tag cannot be combined with the |
| | <permanent-quit/> |
| | tag, and is listed here just for explanatory reasons. |
| <requested-lease | The sender requests an extension of all Leases |
| id=“lease-group-A” | obtained from the receiver, for Replicas held by |
| millis=“123456”/> | the sender as part of the LeaseGroup identified as |
| | lease-group-A |
| | by 123.456 sec from the time of this Message. |
| <requested-lease | The sender requests an extension of all Leases |
| id=“lease-group-B” | obtained from the receiver, for Replicas held by |
| millis=“9999”/> | the sender as part of the LeaseGroup identified as |
| | lease-group-B |
| | by almost 10 sec from the time of this Message. |
| <granted-lease | The sender grants an extension of all Leases |
| id=“lease-group-C” | obtained from the sender, for Replicas held by the |
| millis=“67890”/> | receiver as part of the LeaseGroup identified as |
| | lease-group-C |
| | by almost 68 sec. |
| <granted-lease | The sender grants an extension of all Leases |
| id=“lease-group-D” | obtained from the sender, for Replicas held by the |
| millis=“23456789”/> | receiver as part of the LeaseGroup identified as |
| | lease-group-D |
| | by 23,456.789 sec. |
| <request> | This indicates the beginning of the section that |
| | asks for initial Leases for one or more Objects. |
| <entity id=“some-object-id#1”> | The sender would like to obtain an initial Lease |
| | for an Entity with identity |
| | Some-object-id#1 |
| <access-path> | In case the receiver does not have a Replica of the |
| | requested Object, the sender requests the receiver |
| | to access the Object through this access path, and |
| | return the Replica when it has it. |
| <step> | This describes the first step of the access path. It |
| | identifies the Node that the receiver is supposed |
| | to contact in order to obtain the Replica. |
| <xmpp>foo@bar.com/bar</xmpp> | One of the addresses by which the Node described |
| | in the first step of the access path can be reached. |
| | This indicates it can be reached at this XMPP ID. |
| <email>foo@mail.bar.com</email> | Another one of the addresses by which the Node |
| | described in the first step of the access path can |
| | be reached. This indicates it can be reached by |
| | this e-mail address. |
| </step> | |
| <step> | This describes the second step of the access path. |
| <xmpp>foo2@bar.com</xmpp> | It identifies the Node that the Node identified in |
| <email>foo2@mail.bar.com</email> | the first step is supposed to contact in order to |
| </step> | obtain the Replica. |
| </access-path> | |
| <scope n=“2”/> | Indicates that the sender would like to obtain |
| | Leases not only for the requested Entity, but the |
| | Entity's neighbor Objects with scope 2. |
| <request-lease millis=“12345”/> | Indicates that the sender would like to obtain a |
| | Lease for this Entity for 12.345 seconds. |
| </entity> | |
| <relationship id=“some-rel-id#1”> | The sender would like to obtain an initial Lease |
| | for a Relationship with identity |
| | some-rel-id#1 |
| <access-path> | In case the receiver does not have a Replica of the |
| | requested Object, the sender requests the receiver |
| | to access the Object through this access path. |
| <step> | This describes the first (and here, only) step of the |
| <xmpp>foo2@bar.com</xmpp> | access path. It identifies the Node that the receiver |
| <email>foo2@mail.bar.com</email> | is supposed to contact in order to obtain the |
| </step> | Replica. This mechanism is identical to the one |
| | for Entities. |
| </access-path> | |
| <scope n=“3”/> | Indicates that the sender would like to obtain |
| | Leases not only for the requested Relationship, |
| | but the Relationship's neighbor Objects with |
| | scope 3. |
| <request-lease millis=“234567890”/> | Indicates that the sender would like to obtain a |
| | Lease for this Relationship for 234,567.89 |
| | seconds. |
| </relationship> | |
| </request> | |
| <cancel> | Starts the section that enumerates the Leases that |
| | the sender would like to cancel. |
| <object id=“some-object-id#4”/> | The sender would like to cancel the Leases for the |
| <object id=“some-object-id#5”/> | two Objects with identifiers: |
| | some-object-id#4 |
| | some-object-id#5 |
| <leasegroup id=“lease-group-X”/> | The sender would like to cancel the LeaseGroup |
| | with the identifier: |
| | lease-group-X |
| </cancel> | |
| <request-lock> | Starts the section that enumerates the Objects |
| | whose Locks the sender would like to obtain from |
| | the receiver. |
| <object id=“some-object-id#1”/> | The sender would like to obtain the lock for the |
| | Object with identity: |
| | some-object-id#1 |
| </request-lock> | |
| <deleted> | Starts the section that enumerates the Objects that |
| | the sender has deleted semantically, or whose |
| | deletion the sender forwarded. |
| <object id=“some-object-id#8”/> | The sender has semantically deleted, or forwards |
| <object id=“some-object-id#9”/> | the semantic deletion of the Objects with |
| | identities: |
| | some-object-id#8 |
| | some-object-id#9 |
| </deleted> | |
| <changes> | Starts the section that lists all changes to shared |
| | Objects that the sender needs to tell the receiver |
| | about. |
| <object id=“some-object-id#2”> | Indicates that something has changed about an |
| | Object with identity |
| | some-object-id#2 |
| <property | Indicates that a Property whose PropertyType is |
| id=“some-property” | identified using identifier |
| time=“12:34:56”> | some-property |
| | of the enclosing Object has changed at |
| | 12:34:56 UTC. |
| <new>The new value.</new> | The new value of the Property of the enclosing |
| | Object is |
| | The new value. |
| | The actual encoding format of the value depends |
| | on the data type of the corresponding |
| | PropertyType. |
| </property> | |
| </object> | |
| </property-changes> | |
| <push-lock> | Starts the section enumerating the Objects whose |
| | Locks are moving from the sender to the receiver |
| <object id=“some-object-id#2”/> | The sender relinquishes, to the receiver, the Lock |
| </push-lock > | of the Object with identity |
| | some-object-id#2 |
| <push-home> | Starts the section enumerating the Objects whose |
| | Home Replica moves from the sender to the |
| | receiver. |
| <object id=“some-object-id#22”/> | The sender gives up being the Home Replica, and |
| | makes the receiver have the Home Replica for the |
| | Object with identity |
| | some-object-id#22 |
| </push-home> | |
| <resynchronize> | Starts the section enumerating the identities of |
| | those Objects that the sender would like to |
| | resynchronize. If this section exists but is empty, |
| | it indicates “resynchronize all Objects that |
| | receiver believes sender has obtained Replicas for |
| | from receiver” |
| <object id=“referenced-object-#2”/> | The sender would like the receiver to resend the |
| | Object with identity |
| | referenced-object-#2 |
| </resynchronize> | |
| <renew-zombie millis=“12345”> | Starts the section enumerating the identities of |
| | those Objects whose Leases have expired from the |
| | receiver, and which the sender would like to |
| | renew. Sender would like to renew these Zombies |
| | for 12.345 seconds. |
| <object id=“some-object-id#6”/> | The sender would like the receiver to renew the |
| <object id=“some-object-id#7”/> | zombie Objects with identities |
| | some-object-id#6 |
| | some-object-id#7 |
| </renew-zombie> | |
| <received-complete-entities> | Starts the section in-lining all “complete” Entities |
| | that the sender wants the receiver to know about |
| | in this Message. This Message contains or |
| | references all Relationships that Entities listed in |
| | this section participate in. |
| <leasegroup id=“lease-group-A”> | All Objects contained in this LeaseGroup, |
| | identified as LeaseGroup |
| | lease-group-A |
| | share the same expiration time and will be |
| | renewed for the same duration. |
| <entity | Specifies all information about an Entity. Here, |
| id=“requested-object-#1” | the Entity has identity |
| type=“meta-type-#1” | requested-object-#1 |
| created=“11:22:33” | The Entity has an EntityType with identity |
| updated=“22:33:44”> | meta-type-#1 |
| | It was created and updated at 11:22:33 UTC and |
| | 22:33:44 UTG, respectively. |
| <property id=“some-property-type”> | A section specifying the value of the enclosing |
| | Entity's Property whose PropertyType has |
| | identity |
| | some-property-type |
| <new>The initial value</new> | The value of the Property is |
| | The initial value |
| | The actual encoding format of the value depends |
| | on the data type of the corresponding |
| | PropertyType. |
| </property> | |
| </entity> | |
| </leasegroup> | |
| <leasegroup id=“lease-group-B”> | All Objects contained in this LeaseGroup, |
| | identified as LeaseGroup |
| | lease-group-B |
| | share the same expiration time and will be |
| | renewed for the same duration. |
| <entity ...> | Analogous to above |
| </leasegroup> | |
| </received-complete-entities> | |
| <received-incomplete-entities> | Starts the section in-lining all “incomplete” |
| | Entities that the receiver needs to know about. |
| | This Message does not contain or reference all |
| | Relationships that Entities listed in this section |
| | participate in. |
| <leasegroup id=“lease-group-B”> | Analogous to above |
| <entity | Analogous to above |
| id=“requested-object-#2” | |
| type=“meta-type-#1” | |
| created=“11:22:33” | |
| updated=“22:33:44”> | |
| <property id=“some-property-type”> | Analogous to above |
| <new>The initial value</new> | Analogous to above |
| </property> | |
| </entity> | |
| </leasegroup> | |
| </received-incomplete-entities> | |
| <received-relationships> | Starts the section in-lining all Relationships that |
| | the receiver needs to know about. This Message |
| | contains or references all Entities that act as either |
| | source or destination of the Relationships listed in |
| | this section. |
| <leasegroup id=“lease-group-A”> | All Objects contained in this LeaseGroup, |
| | identified as LeaseGroup |
| | lease-group-A |
| | share the same expiration time and will be |
| | renewed for the same duration. |
| <relationship | Specifies all information about an Relationship. |
| id=“requested-object-#3” | Here, the Relationship has identity |
| type=“meta-type-#2” | requested-object-#3 |
| source=“source-#1” | The Relationship has a RelationshipType with |
| destination=“destination-#2” | identity |
| created=“11:11:11” | meta-type-#2 |
| updated=“22:22:22”> | It has a source Entity whose identity is |
| | source-#1 |
| | And a destination Entity whose identity is |
| | destination-#2 |
| | It was created and updated at 11:11:11 UTC and |
| | 22:22:22 UTC, respectively. |
| <property id=“some-property-type”> | A section specifying the value of the enclosing |
| | Relationship's Property whose PropertyType has |
| | identity |
| | some-property-type |
| <new>The initial value</new> | The value of the Property is |
| | The initial value |
| | The actual encoding format of the value depends |
| | on the data type of the corresponding |
| | PropertyType. |
| </property> | |
| </relationship> | |
| </leasegroup> | |
| </received-relationships> | |
| <referenced-entities-complete> | Starts the section that contains the identifiers of |
| | all of those Entities that the receiver knows about |
| | already and which are now “complete” by virtue |
| | of the content of this Message. |
| <object id=“referenced-object-#2”/> | Identifies an Entity with identity |
| | referenced-object-#2 |
| </referenced-entities-complete> | |
| <referenced-relationships> | Starts the section that contains the identifiers of |
| | all those Relationships that the receiver knows |
| | about already and which are required to make the |
| | sent Entities in the “complete” section complete. |
| <object id=“referenced-object-#5”/> | Identifies a Relationship with identity |
| | referenced-object-#5 |
| </referenced-relationships> | |
| <request-roleplayertable-objects> | Starts the section that lists the identities of the |
| | Entities which the sender would like to make |
| | “complete”. |
| <object id=“some-object-id#2”/> | Identifies two Entities with identities |
| <object id=“some-object-id#3”/> | some-object-id#2 |
| | some-object-id#3 |
| </request-roleplayertable-objects> | |
| <transmogrified> | Starts the section that identifies those Objects |
| | whose type has been changed on the side of the |
| | sender. |
| <entity | The Entity with identity |
| id=“requested-object-#11” | Requested-object-#11 |
| type=“meta-type-#11” | Has changed its type to MetaType with identity |
| updated=“22:33:44”> | Meta-type-#11 |
| | at time 22:33:44 UTC. |
| <property id=“some-property”> | Indicates that during the type change, a Property |
| | changed its value. The Property's PropertyType |
| | has identifier |
| | some-property |
| <new>The mogrified</new> | The Property now has value |
| | The mogrified |
| | The actual encoding format of the value depends |
| | on the data type of the corresponding |
| | PropertyType. |
| </property> | |
| </entity> | |
| </transmogrified> | |
| <request-replica-graph> | Indicates that the sender would like to obtain |
| | information about which Nodes the receiver |
| | participates in Leases with. |
| <object id=“some-rel-id#1”> | Indicates that the sender would like to obtain |
| | information about which Nodes participate in |
| | Leases for an Object with identity |
| | some-rel-id#1 |
| | with the receiver. |
| </request-replica-graph> | |
| <replica-graph> | Indicates the begin of the section in which the |
| | sender responds to a replica graph request from |
| | the receiver. |
| <graph id=“some-object-id#2” | Indicates the beginning of a replica graph as seen |
| | by the sender about an Object with identity |
| | some-object-id#2 |
| | This section may include at most one graph node |
| | whose towardshome attribute is set to true. |
| <graph-node home=“true”> | Indicates that the Object's Home Replica can be |
| | found at this Node in the Replica Graph. |
| <xmpp>some@where.com</xmpp> | The Node is identified by this XMPP identifier |
| | (see above). |
| </graph-node> | |
| <graph-node> | Indicates that another of the Object's Replicas |
| | (that is not the Home Replica) can be found at this |
| | Node in the Replica Graph. |
| <xmpp>other@where.com</xmpp> | The Node is identified by this XMPP identifier |
| | (see above). |
| </graph-node> | |
| </graph> | |
| </replica-graph> | |
| <meta-message> | In the “X-PRISO on multiple meta-levels” |
| ... | embodiment of the present invention, this section |
| </meta-message> | may exist and contain “meta” information, i.e. |
| | information about the information model in the |
| | Distributed System. This syntax of this section is |
| | identical to the overall Message (and thus |
| | recursive), but it refers to information “one meta- |
| | level up”. |
| | It itself may contain a meta-message tag, in case |
| | X-PRISO is used on more than two meta-levels at |
| | a time. |
| | Alternatively, the content of this tag may be |
| | exchanged through a separate Message or “out of |
| | band”. |
| </message> | End of message tag. |

While the foregoing has been with reference to a particular embodiment of the invention, it will be appreciated by those skilled in the art that changes in this embodiment may be made without departing from the principles and spirit of the invention as defined in the appended claims.

1. A distributed system for sharing a plurality of related pieces of information, comprising two or more heterogeneous nodes capable of being connected to each other wherein the nodes exchange a plurality of messages according to a common communication protocol that runs concurrently on a plurality of reliable or non-reliable communication transports between the nodes, wherein the shared pieces of information may be updated frequently by one or more of the nodes and wherein the shared information is kept coherent across the nodes.

2. The distributed system of claim 1, wherein the shared information further comprises one or more entity objects and one or more relationship objects, each entity object and each relationship object being identified using a unique identifier.

3. The distributed system of claim 2, wherein each entity object and each relationship object further comprises one or more properties, each of which carries atomic information.

4. The distributed system of claim 3 further comprising an information model, agreed to by the nodes of the distributed system, that governs the structure of the shared information for the purpose of sharing it among the nodes, and for when nodes communicate with each other about the shared information, wherein the entity objects, relationship objects and their properties are instances of the information model.

5. The distributed system of claim 4, wherein the information model further comprises a model that defines the structure and relationships of configuration management and version control information.

6. The distributed system of claim 4, wherein the information model further comprises a model that defines the structure and relationships of access control information for pieces of shared information, and wherein the pieces of shared information are subject to the access control rules represented by the pieces of shared information that are instances of the access control information concepts in the information model.

7. The distributed system of claim 4, wherein the information model is fixed prior to commencing operation of the distributed system.

8. The distributed system of claim 4, wherein a core part of the information model is fixed prior to commencing operation of a first instance of the distributed system and wherein the nodes may dynamically discover and support other parts of the information model during operation by gaining knowledge of the other parts of the information model from one of the other nodes or an information model distribution facility.

9. The distributed system of claim 8, further comprising a second instance of the distributed system, running concurrently with the first instance of the distributed system wherein each node in the first instance of the distributed system is associated with exactly one node of the second instance of the distributed system, the second instance of the distributed system being governed by a “meta” information model that the nodes of the second instance of the distributed system agree on, and sharing the information model of the first instance as the second instance's shared information, and the first instance of the distributed system using the information model shared as the shared information by the second instance as its information model.

10. The distributed system of claim 1, wherein each of the nodes of the distributed system holds a replica of each piece of shared information.

11. The distributed system of claim 1, wherein each node of a first portion of the nodes of the distributed system holds a replica of all of the pieces of the shared information, and each node of a second portion of the nodes of the distributed system holds a replica of only some of the pieces of the shared information, with different nodes in the second portion holding replicas of different pieces of the shared information.

12. The distributed system of claim 1, wherein none of the nodes of the distributed system holds a replica of all of the pieces of the shared information.

13. The distributed system of claim 1, wherein none of the nodes of the distributed system holds a replica of all of the pieces of shared information for security reasons, and wherein some of the replicas of some of the pieces of the shared information at some nodes are of an incomplete type.

14. The distributed system of claim 1, wherein each piece of shared information has a home node associated with the piece of shared information, the home node being the same for each replica of the same piece of shared information, and wherein the replica of the piece of shared information held by the home node is called a home replica.

15. The distributed system of claim 14, wherein each piece of shared information further comprises one or more replicas of the piece of shared information wherein each replica that is not the home replica for the piece of the shared information is subject to a lease that is negotiated between a granting node, being one of the home node and another node having a replica of the piece of shared information, and the node holding the replica wherein the lease has a duration up to an expiration time during which the replica is coherent with the replica of the piece of shared information at the granting node.

16. The distributed system of claim 15, wherein one or more leases for replicas, between the same granting node and the same node receiving the leases, are grouped together in a lease group wherein each lease for each replica has the same expiration time.

17. The distributed system of claim 16, wherein the lease group is split into a first and second new lease group wherein the replicas from the lease group are split into the first and second lease groups.

18. The distributed system of claim 15, wherein a node holding a replica requests an extension of the lease for the replica prior to the expiration time from the granting node, wherein the granting node one of grants and denies the request for the lease extension.

19. The distributed system of claim 15, wherein each granting node notifies each node, to which there is a lease of a replicathat has not expired, of changes to the particular piece of shared information and the node from which it has been granted a lease that has not expired yet for the particular replica.

20. The distributed system of claim 15, wherein exactly one node, holding a replica of a particular piece of the shared information, holds a lock for the particular piece of shared information, and wherein changes to the particular piece of shared information are only made to the replica held by the node currently holding the lock for the said particular piece of the shared information.

21. The distributed system of claim 20, wherein the granting node has granted a lease for a replica for piece of shared information to a second node wherein the lease has expired without having been successfully renewed, and the second node possessing the lock for the piece of shared information at the time of lease expiration, the granting node unilaterally retrieving the lock for its own replica of the piece of the shared information once the lease has expired.

22. The distributed system of claim 14, wherein the designation as the home node associated with a piece of shared information may be moved between nodes during the operation of the distributed system.

23. The distributed system of claim 3, wherein each granting node notifies each node, to which there is a lease of a particular piece of information that has not expired, of changes to the particular piece of shared information and the node from which it has been granted a lease that has not expired yet for the particular piece of the shared information and wherein the notification of changes to a first shared entity object comprises one or more of notification of a change of one or more of the properties of the first shared entity object and the new values for the properties, notification of the creation of a relationship object relating to the first shared entity object, notification of deletion of a relationship object relating to the first shared entity object, notification of change of a relationship object relating to the first shared entity object, and notification of deletion of the first shared entity object; and where notification of changes to a second shared relationship object comprises notification of change of one or more of the properties of the second shared relationship object and the new values for the properties, notification of deletion of an entity object that is related to the second shared relationship object, and notification of deletion of the second shared relationship object.

24. The distributed system of claim 15, wherein a node holds a zombie replica which is a replica whose lease has expired and wherein the node requests, from another node, a revival of the zombie replica and the other node grants or denies the zombie revival request.

25. The distributed system of claim 1, wherein each node is identified by one unique node identifier, resolvable by a network transport and routable from the other nodes in the distributed system, for each network transport that may be employed by the node.

26. The distributed system of claim 1, wherein each message is expressed in a XML format.

27. The distributed system of claim 3, wherein the property values are contained within the message.

28. The distributed system of claim 3, wherein property values form a main part of the message and non-property information is quoted within the message.

29. The distributed system of claim 1, wherein a message comprises a plurality of requests and a plurality of responses.

30. The distributed system of claim 1, wherein one or more nodes become unavailable after the operation of the distributed system has commenced, and wherein one or more nodes join the distributed system after the operation of the distributed system has commenced.

31. The distributed system of claim 1, wherein one of the nodes is a test node to test the operation of one or more nodes and of the distributed system.

32. The distributed system of claim 15, wherein each node of the distributed system further comprises:
an information storage unit that stores the replica of one or more pieces of shared information, a first portion of the replicas having non-home replicas subject to a lease from a granting node and a second portion of the replicas being the home replicas; a piece of lock information for each replica indicating which node of the distributed system has a right to update the piece of shared information; and a piece of lease information for each non-home replica indicating the duration of the lease for the non-home replica and the granting node for the lease;
a transaction serializer that guards the information storage unit against unmanaged concurrent access;
a lease manager further comprising a unit that attempts to renew the lease, approaching the expiration time, of the replicas needed by the node, a unit that destroys, when the lease is not renewed, replicas subject to the lease after the expiration time and a unit, when the node is the granting node, that grants or denies requests for renewed leases from other nodes; and
one or more protocol managers wherein each protocol manager is responsible for a particular communication transport, each protocol manager receives incoming messages and converts the incoming message into an internal protocol, and sends outgoing messages wherein the outgoing message is converted from the internal protocol to the particular communication transport protocol;
one or more proxy units connected to the information storage unit and to one or more of the protocol managers, each proxy unit controlling access, between the node and a second node, to the plurality of replicas stored in the information storage unit, each proxy unit receiving incoming messages using the internal protocol from one or more protocol managers, sending outgoing messages to the protocol manager, detecting that incoming messages were lost during transport, and creating, sending, receiving and managing messages that request from other nodes to resend messages they sent, and that responds to incoming requests from other nodes to resend messages;
one or more priority queues, one for each proxy unit, that store incoming messages in the internal protocol according to the sequence in which they were created by a sending node; and
for each proxy unit, a set of messages that were sent by that proxy to another node but whose receipt has not been acknowledged yet by the other node and a set of messages that were received from another node, but whose receipt the node has not acknowledged yet to the other node.

33. The system of claim 32, wherein the node holds a zombie replica which is a replica whose lease has expired and wherein the lease manager further comprises a unit that initiates and responds to zombie revival requests.

34. The system of claim 32, wherein the proxy unit further comprises a unit to send a given message in multiple copies to a destination node through multiple communication transports, receive such messages from the destination node through multiple communication transports, and discard all but one copy of the received messages.

35. The system of claim 32, wherein the proxy unit further comprises a message confirmation unit that confirms receipt of each message originating from the proxy unit to another node and confirms receipt of each incoming message from another node to perform a message handshaking protocol.

36. The system of claim 32, further comprising a lease manager that manages leases to other nodes and leases obtained from other nodes by grouping replicas into a lease group with the same expiration times and granting node.

37. The system of claim 32, wherein each proxy unit, in response to a replication request from a requesting node, grants a lease to the requesting node for all replicas available at the node.

38. The system of claim 32, wherein each proxy unit, in response to a replication request from a requesting node, grants a lease to a portion of the replicas available at the node to the requesting node.

39. The system of claim 38, wherein the proxy unit determines a portion of the replicas available at the node to which it grants a lease to the requesting node by partitioning the replicas of the entity objects into one or more newly-shared “complete” replicas of entity objects, newly-shared “incomplete” replicas of entity objects, not-shared replicas of entity objects, already-shared but newly-referenced replicas of entity objects, newly-shared replicas of relationship objects, already-shared but newly-referenced replicas of relationship objects, and not-shared replicas of relationship objects.

40. The system of claim 39, wherein the proxy unit further comprises means for converting an “incomplete” replica of entity objects into a “complete” replica by determining a set of relationships related to the entity object, and then obtaining replicas of such related relationships, from other replicas of the same entity object at other nodes from which the node has a lease.

41. The system of claim 39 that partitions entity objects and relationship objects according to a scope parameter provided by the requesting node.

42. The system of claim 32, wherein the proxy unit accumulates outgoing change notifications for a shared piece of information for a period of time, and consolidates the outgoing change notifications, prior to sending them to one or more receiving nodes.

43. The system of claim 32, wherein the programming language constructs to represent the replicas for pieces of shared information at the node are generated from a code generator that uses an information model as its input.

44. The system of claim 35, wherein the handshake operation further comprises deleting confirmed messages from the incoming message list to maintain an unconfirmed incoming message list and deleting confirmed messages from the outgoing message list to maintain an unconfirmed outgoing message list.

45. The system of claim 32, further comprised of a security manager that restricts the responses given to incoming requests by the node.

46. The system of claim 32 further comprising a virtual file system manager unit that converts, in both directions, between the representation of the pieces of shared information by the node, and an external file system view.

47. A method for sharing a plurality of related pieces of information among two or more heterogeneous nodes of a distributed system, wherein the pieces of the shared information may be updated frequently by one or more of the nodes, and wherein the shared information is kept coherent, comprising:
utilizing a common communication protocol that runs on a plurality of reliable or non-reliable communication transports between nodes wherein the common communications protocol is agreed to by the nodes of the distributed system; and
sharing information among the nodes using an information model that governs the structure of the shared information when nodes communicate with each other about the shared information, that is agreed to by the nodes of the distributed system.

48. The method of claim 47, wherein the information model further comprises one or more of entity objects, relationship objects, properties of entity objects and properties of relationship objects.

49. The method of claim 47, where the communications protocol is a symmetrical protocol.

50. The method of claim 47, wherein the sharing of information further comprises exchanging a one or more unique messages between two or more nodes, wherein each unique message is identified by a unique message identifier that is incremented for each new message sent from a first node to a second node, and further comprising, detecting, at the second node, lost messages based on a missing identifier in the sequence of identifiers, so that the second node is able to determine the identifiers of, and to request the resending of lost messages from the first node.

51. The method of claim 47, in which a requesting node may request a replica of a first piece of the shared information from a responding node, the request comprising a unique identifier for the first piece of the shared information, and in which the responding node may or may not grant the request, sending a response comprising the serialized representation of the first piece of the shared information if the lease is granted.

52. The method of claim 5 1, in which the request further comprises a duration for a requested lease, and in which the response further comprises the accepted duration for the lease if the lease was granted.

53. The method of claim 52, in which the response further comprises the lease group in which the responding node has placed the lease of the first piece of information to the requesting node if the lease was granted.

54. The method of claim 53, in which the lease group is a newly created lease group, and in which the response further comprises the expiration time of the newly created lease group.

55. The method of claim 53, in which the request further comprises a requested lease group for the first piece of information.

56. The method of claim 47, in which an intermediate node may act as an intermediary to a first node for a second node, passing on any valid messages from the first node to second node, and from the second node to the first node, with or without inspection and processing of the messages.

57. The method of claim 51, in which the requesting node specifies a scope parameter that indicates which pieces of information other than the directly requested piece of information are requested to be replicated, and, if granted, in which the granting node responds with a plurality of serialized replicas reflecting the scope parameter.

58. The method of claim 57, in which the responding node responds by categorizing serialized replicas of one or more entity objects as complete, or as incomplete entities, and the response further comprising a list of identifiers for replicas of entity objects at requesting node which have now become complete as a result of the response, and the response further comprising a list of identifiers of relationship objects at the requesting node which need to be consulted to determine the correct set of relationship objects related to the now-complete set of entities.

59. The method of claim 58, in which the requesting node further generates and sends a message to the responding node requesting information that allows the requesting node to turn an incomplete replica of an entity object at the requesting node into a complete replica, and in which the responding node responds with the information, or denies to respond.

60. The method of claim 59, in which the requested and obtained information comprises serialized complete replicas of entity objects, serialized incomplete replicas of entity objects, serialized replicas of relationship objects, identifiers of entity objects replicas of which the requesting node holds that become complete as a result of receiving the response, and identifiers of relationship objects replicas of which the requesting node holds that are consulted to construct the complete replicas.

61. The method of claim 52, in which the requesting node may request an extension to a lease obtained from the responding node for a first piece of shared information and for a certain duration, which responding node may or may not grant, responding with the accepted duration for the renewed lease if granted.

62. The method of claim 53, in which the requesting node may request an extension to the set of leases granted through a lease group by a responding node for a certain duration, which the responding node may or may not grant, responding with the accepted duration for the renewed lease group if granted.

63. The method of claim 52, in which the requesting node may request a cancellation of a lease obtained from the responding node for a replica of the first piece of shared information.

64. The method of claim 53, in which the requesting node may request a cancellation of a lease group obtained from the responding node, thereby canceling the leases of all replicas held by requesting node and subject to the said lease group.

65. The method of claim 47 further comprising a first node receiving an announcement of the permanent unavailability of a second node to share information and, in response to the announcement, terminating all leases of that first node participates in with the second node and removing information held by first node about the second node.

66. The method of claim 47 further comprising a second node receiving an announcement of the temporary unavailability of a first node to share information for some expected duration and, in response to the announcement, the second node holding the outgoing messages to first node until the first node is again available.

67. The method of claim 66, wherein holding the outgoing messages further comprises consolidating the held outgoing messages syntactically or semantically in order to reduce the number of outgoing messages and the size of their information content.

68. The method of claim 47, wherein a first node generates and sends a message to a second node requesting update rights for a first piece of shared information a replica of which it holds, the replica being subject to a currently active lease between the first node and second node in either direction, and wherein the first node receives, from second node, a message in response to the request, granting or denying the request for update rights; and further, if the request is granted, wherein the update rights to replicas of the first piece of information pass from the second node to the first node.

69. The method of claim 52, wherein the expiration or cancellation of a lease causes the replicas subject to the lease to be deleted immediately at the node that had obtained the lease.

70. The method of claim 52, wherein the expiration or cancellation of a lease causes the replicas subject to the lease to become zombies at the node that had obtained the lease.

71. The method of claim 70, in which a first node holding one or more zombies generates and sends a message to a second node requesting the revival of the zombies, the message comprising the unique identifiers of the pieces of shared information whose replicas became zombies, and in which the second node may grant or reject the zombie revival request, issuing a new lease or lease group if the request was granted, and the response further comprising the serialized representation of the revived zombies.

72. The method of claim 47 further comprising propagating updates made to any replica R of a first piece of the shared information at a first node to all nodes holding replicas of the first piece of the shared information, and said other replicas being updated to the same state as the updated replica R.

73. The method of claim 72 further comprising propagating updates along the edges of the replication graph.

74. The method of claim 72, wherein updates are updates of entity objects or updates of relationship objects, updates of a entity object being a) updates to one or more of the properties of the entity object, b) creation of relationship objects related to the entity object, c) deletion of relationship objects related to the entity object, d) updates to relationship objects related to the entity object, e) deletion of the entity object itself, and where updates of a relationship object being a) updates to one or more of the properties of the relationship object, b) deletions of an entity object related to the relationship object, c) the deletion of the relationship object itself.

75. The method of claim 74 further comprising transmogrification updates of entity objects or relationship objects.

76. The method of claim 47 in which a first node generates and sends a message to a second node asking for a resynchronization of a set of replicas that it has leased from the second node, the message comprising the unique identifiers of the pieces of shared information of which the set of replicas are replicas, and in which the second node grants or denies the resynchronization request, responding with a message comprising a serialized representation of the replicas for which the request is granted.

77. The method of claim 51, in which a first node generates and sends a message to a second node asking for the list of nodes that the second node participates in a lease with for first replica, the message comprising the unique identifier of the piece of shared information of which the first replica is a replica, and in which the second node grants or denies the request, responding with a message comprising the identifiers of all or some of the nodes that it participates in a lease with for first replica if the request is granted.

78. The method of claim 77, in which the first node modifies the replica graph by canceling a lease for the first replica of a piece of shared information that it has with the second node, and establishes a new lease for a replica of said piece of shared information with a third node, the third node's identifier having been among the node identifiers sent back by the second node when asked for the list of nodes that the second node participates in a lease with for its replica of said piece of shared information.

79. The method of claim 47, in which a node responds to an incoming request with only some of the information it has, instead of the complete response.

80. The method of claim 79, in which the node denies an incoming lease request for a replica for a piece of shared information, for security reasons.

81. The method of claim 79, in which a node responds to an incoming lease request for a replica for a piece of shared information with only a portion of the serialized representation of the requested piece of shared information, for security reasons.

82. The method of claim 81, in which a node responds to an incoming lease request for a replica for a piece of shared information by stating that the piece of information is of a more general and less specific type than it is, for security reasons.

83. The method of claim 48, wherein a node serializes only some of the properties of a shared piece of information during communication with another node, for security reasons.

84. The method of claim 48, wherein a node uses a special value indicating “the value is private” when serializing a property of a shared piece of information during communication with another node, for security reasons.
